(19) United States
(12) Patent Application Publication
(10) Pub. No.: US 2026/0290709 A1
(43) Pub. Date: Sep. 24, 2026

(54) SEMICONDUCTOR DEVICE

(71) Applicant: Murata Manufacturing Co., Ltd., Kyoto-fu (JP)

(72) Inventors: Yoshimasa YOSHIOKA, Nagaokakyo-shi (JP); Hiroshi NAKAGAWA, Nagaokakyo-shi (JP)

(73) Assignee: Murata Manufacturing Co., Ltd., Kyoto-fu (JP)

(21) Appl. No.: 19/689,223

(22) Filed: May 27, 2026

Related U.S. Application Data
(63) Continuation of application No. PCT/JP2024/019384, filed on May 27, 2024.

(30) Foreign Application Priority Data
Nov. 28, 2023 (JP) 2023-200781

(51) Int. Cl. H01G 4/38; H01G 4/005; H01G 4/33

(52) U.S. Cl. CPC H01G 4/385; H01G 4/005; H01G 4/33

(57) ABSTRACT

A semiconductor device includes a semiconductor base that has a lower surface, an upper surface spaced from the lower surface in a height direction, and a side surface connecting the upper and lower surfaces, and a capacitive portion that is disposed in a direction of the side surface of the semiconductor base, the lower surface is to face a mounting surface on which the semiconductor device is to be mounted, the capacitive portion has a multilayer structure including at least a first dielectric layer that is disposed along the side surface and first and second conductive layers that face each other with the first dielectric layer interposed therebetween, the semiconductor base includes at least one trench portion that has an opening in the side surface, and at least a part of the capacitive portion is inside the at least one trench portion.

### CROSS-REFERENCE TO RELATED APPLICATIONS

This application claims benefit of priority to International Patent Application No. PCT/JP2024/019384, filed May 27, 2024, and to Japanese Patent Application No. 2023-200781, filed Nov. 28, 2023, the entire contents of each are incorporated herein by reference.

### BACKGROUND

### Technical Field

The present disclosure relates to a semiconductor device.

### Background Art

In a semiconductor device in International Publication No. 2019/208226 disclosed as an example of a semiconductor device that includes a capacitive portion, a capacitive portion that includes a dielectric film and a conductive film is provided on a main surface of a semiconductor base.

### SUMMARY

For example, the semiconductor device described above can be mounted and used on a printed circuit board. As for the semiconductor device in International Publication No. 2019/208226, however, there is room for improvement from the perspective of inhibiting an area (a mounting area) required for mounting the semiconductor device from increasing and of increasing electrostatic capacity (capacitance).

Accordingly, the present disclosure provides a semiconductor device that inhibits a mounting area from increasing and that enables the electrostatic capacity of a capacitive portion to increase.

A semiconductor device according to an aspect of the present disclosure includes a semiconductor base that has a lower surface, an upper surface spaced from the lower surface in a height direction, and a side surface connecting the upper surface and the lower surface; and a capacitive portion that is disposed in a direction of the side surface of the semiconductor base. The lower surface is to face a mounting surface on which the semiconductor device is to be mounted. The capacitive portion has a multilayer structure including at least a first dielectric layer that is disposed along the side surface and a first conductive layer and a second conductive layer that face each other with the first dielectric layer interposed therebetween. The semiconductor base includes at least one trench portion that has an opening in the side surface, and at least a part of the capacitive portion is located inside the at least one trench portion.

A semiconductor device according to the present disclosure inhibits a mounting area from increasing and enables the electrostatic capacity of a capacitive portion to increase.

### BRIEF DESCRIPTION OF THE DRAWINGS

FIG. 1 is a schematic perspective view of a semiconductor device according to a first embodiment;

FIG. 2 is a schematic sectional view of the semiconductor device taken along line II-II in FIG. 1;

FIG. 3 schematically illustrates an example of a circuit structure in the semiconductor device in FIG. 1;

FIG. 4A is a schematic sectional view of processing illustrating a method of manufacturing the semiconductor device in FIG. 1;

FIG. 4B is a schematic sectional view of processing illustrating the method of manufacturing the semiconductor device in FIG. 1;

FIG. 4C is a schematic sectional view of processing illustrating the method of manufacturing the semiconductor device in FIG. 1;

FIG. 4D is a schematic sectional view of processing illustrating the method of manufacturing the semiconductor device in FIG. 1;

FIG. 4E is a schematic sectional view of processing illustrating the method of manufacturing the semiconductor device in FIG. 1;

FIG. 4F is a schematic sectional view of processing illustrating the method of manufacturing the semiconductor device in FIG. 1;

FIG. 4G is a schematic sectional view of processing illustrating the method of manufacturing the semiconductor device in FIG. 1;

FIG. 4H is a schematic sectional view illustrating a state in which the semiconductor device in FIG. 1 is mounted;

FIG. 5A is a plan view of an example of a main surface of a semiconductor substrate that includes trench portions;

FIG. 5B is a plan view of an example of a main surface of a semiconductor substrate that includes trench portions;

FIG. 5C is a plan view of an example of a main surface of a semiconductor substrate that includes trench portions;

FIG. 6 is a schematic sectional view of a semiconductor device according to a modification;

FIG. 7 schematically illustrates an example of a circuit structure in the semiconductor device in FIG. 6;

FIG. 8 is a schematic top view of a semiconductor device according to a second embodiment;

FIG. 9 is a schematic sectional view of the semiconductor device taken along line IX-IX in FIG. 8;

FIG. 10 schematically illustrates an example of a circuit structure in the semiconductor device in FIG. 8;

FIG. 11 is a schematic top view of a semiconductor device according to a first modification;

FIG. 12 is a schematic sectional view of the semiconductor device taken along line XII-XII in FIG. 11;

FIG. 13 schematically illustrates an example of a circuit structure in the semiconductor device in FIG. 11;

FIG. 14 is a schematic top view of a semiconductor device according to a second modification;

FIG. 15 is a schematic sectional view of a semiconductor device taken along line XV-XV in FIG. 14;

FIG. 16 is a schematic sectional view of the semiconductor device taken along line XVI-XVI in FIG. 15;

FIG. 17 is a schematic sectional view of a wiring layer of a semiconductor device according to a third modification;

FIG. 18 is a schematic sectional view of the semiconductor device taken along line XVIII-XVIII in FIG. 17;

FIG. 19 is a schematic perspective view of a semiconductor device according to a third embodiment;

FIG. 20 is a schematic sectional view of a circuit substrate according to a fourth embodiment; and

FIG. 21 is a schematic sectional view of another circuit substrate according to the fourth embodiment.

### DETAILED DESCRIPTION

### Underlying Knowledge Forming Basis of the Present Disclosure

The present inventors have conducted research diligently in order to inhibit a mounting area from increasing and to increase capacitance and consequently acquired knowledge described below.

An existing semiconductor device is configured such that a capacitive portion (such as a trench capacitor) is provided on a main surface of a semiconductor base, and the semiconductor base is mounted on a mounting substrate in the direction of a back surface thereof (a surface that is located opposite the main surface). As for semiconductor devices thus configured, a semiconductor device that has high capacitance is difficult to mount on the limited mounting area in some cases. For example, if the area of the main surface of the semiconductor base on which the capacitive portion is formed is increased to increase the capacitance, a chip area increases, and the mounting area increases. On the other hand, it can be thought that the mounting area is maintained, and an effective area of the capacitive portion is increased in a manner in which trenches are densely arranged, or the depths of trenches are increased. However, processing of such trenches is limited. For example, even though the thickness of the semiconductor base is increased (a chip thickness is increased), it is difficult to form trenches deeply depending on the increased thickness in some cases. The “mounting area” is needed to mount the semiconductor device on the mounting substrate, and an example thereof is an area of a surface (an XY surface) of the semiconductor device in a direction perpendicular to a thickness direction (a height direction).

In view of this, the present inventors have conducted research and consequently found that the mounting area is inhibited from increasing, and the capacitance can be increased in a manner in which a trench portion and a capacitive portion are provided in the direction of a side surface of a semiconductor base. The present inventors have arrived at the disclosure described below based on these new findings.

Embodiments of the present disclosure will hereinafter be described with reference to the drawings. The embodiments do not limit the present disclosure. In some drawings, an X-axis, a Y-axis, and a Z-axis that are perpendicular to each other are schematically illustrated for reference. In the drawings, substantially like members are designated by using like reference signs, and a duplicated description is appropriately omitted. In some cases, dimensions of elements in the drawings are exaggerated for illustration and are not necessarily illustrated to scale.

For convenience of description, words representing directions such as “above”, “below”, and “direction” are used on the assumption that these are used under normal use, but this does not mean that a state in which a semiconductor device according to the present disclosure is used is limited.

### First Embodiment

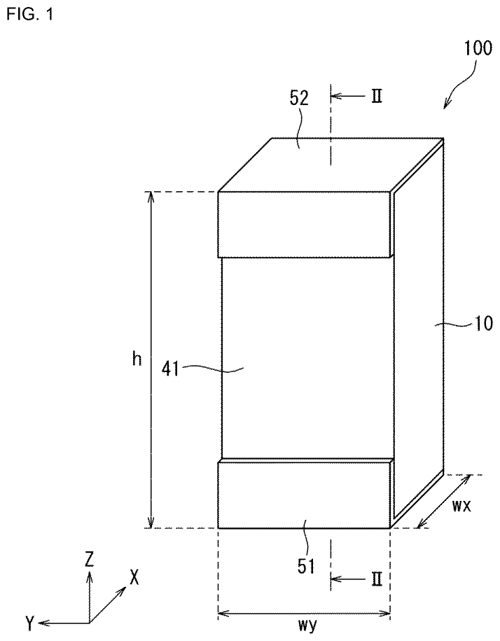

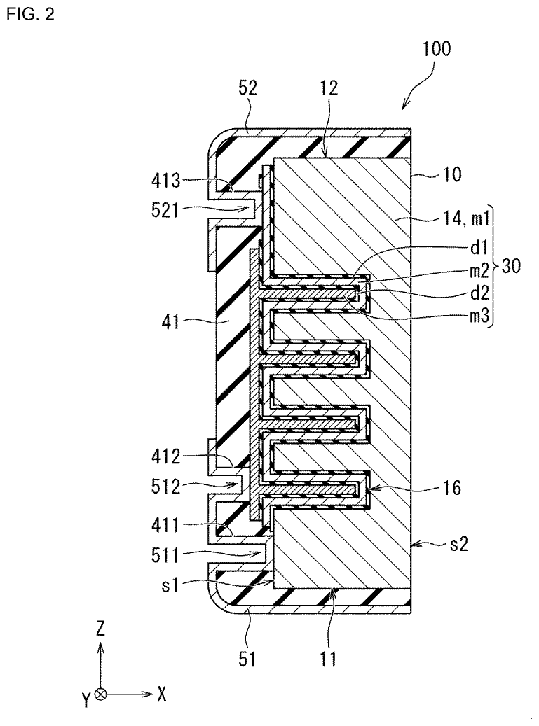

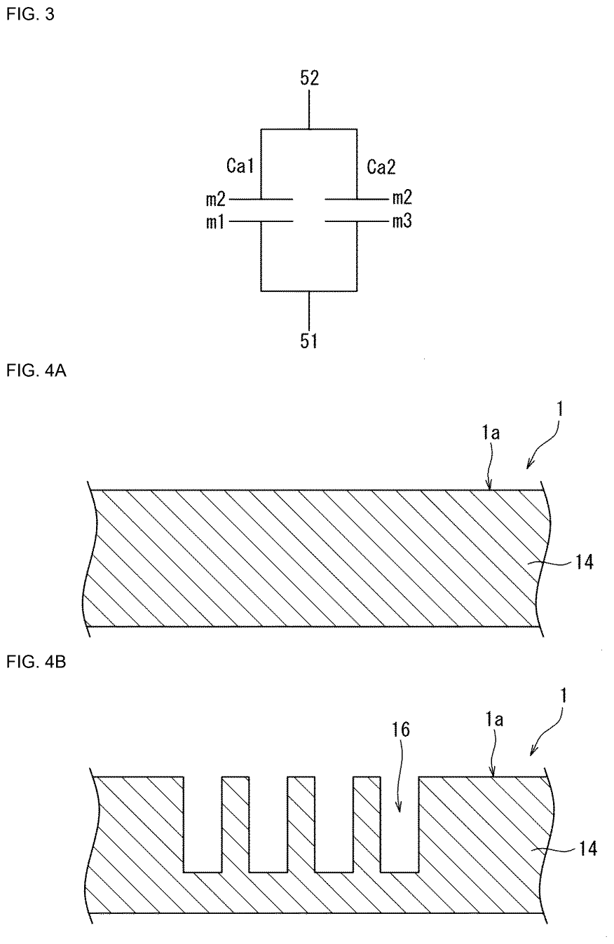

FIG. 1 is a schematic perspective view of a semiconductor device according to a first embodiment. FIG. 2 is a schematic sectional view of the semiconductor device in FIG. 1 taken along line II-II. FIG. 3 schematically illustrates an example of a circuit structure in the semiconductor device in FIG. 1.

For example, as illustrated in FIG. 1, a semiconductor device 100 has a substantially rectangular cuboid shape. In this example, for ease of understanding, the height, depth, and width of the semiconductor device 100 that has a rectangular cuboid shape are illustrated so as to be parallel with the X-axis, the Y-axis, and the Z-axis. The semiconductor device 100 is mounted such that a lower surface of the semiconductor device 100 faces a mounting surface of a mounting substrate. The Z-axis corresponds to the height direction (the thickness direction) of the semiconductor device that is mounted and is perpendicular to, for example, the mounting surface.

The size of the semiconductor device 100 is not particularly limited. For example, the height (the thickness) h of the semiconductor device 100 is 1.0 mm, and the width wx in an X-direction and the width wy in a Y-direction are 0.5 mm. For example, the mounting area is 0.5 mm×0.5 mm.

As illustrated in FIG. 1 and FIG. 2, the semiconductor device 100 includes a semiconductor base 10, a capacitive portion 30, electrode layers 51 and 52, and an insulating layer 41.

For example, the semiconductor base 10 has a substantially rectangular cuboid shape. The semiconductor base 10 has a lower surface 11, an upper surface 12 that is spaced from the lower surface 11 in a Z-direction (the height direction), and side surfaces that connect the lower surface 11 and the upper surface 12 to each other. The lower surface 11 is to face the mounting surface. The side surfaces of the semiconductor base 10 include a first surface s1 and a second surface s2 that is spaced in a direction (here, the X-direction) intersecting with the first surface s1.

An example of the semiconductor base 10 is a Si base. According to the present embodiment, the semiconductor base 10 is a Si base that includes a low-resistance portion 14 that is conductive. The low-resistance portion 14 is a semiconductor portion composed of a low-resistance semiconductor (such as n-type Si or p-type Si).

The semiconductor base 10 includes trench portions 16 that have openings on a side surface (here, the first surface s1). Examples of the trench portions 16 include bottomed holes. According to the present embodiment, the multiple openings of the trench portions 16 are spaced from each other on the first surface s1.

For example, the depth direction (the direction from the openings of the trench portions 16 toward the bottom surfaces of the trench portions 16) of the trench portions 16 is parallel with the mounting surface (here, the XY surface). In an example illustrated in FIG. 2, the depth direction of the trench portions 16 is parallel with a normal direction (the X-direction) to the first surface s1. The meaning of “parallel” may include substantially parallel even though misalignment occurs due to processing such as processing of a trench. For example, the depths of the trench portions 16 in the X-direction from the openings to the bottom surfaces are 30 μm. In FIG. 2, sectional shapes of the trench portions 16 in the depth direction are rectangular shapes elongated in the X-direction, but may be triangular or trapezoidal shapes formed such that trench widths gradually decrease toward the bottom surfaces. In FIG. 2, the multiple trench portions 16 are formed on the first surface s1, but at least one of the trench portions 16 suffices.

The capacitive portion 30 is disposed in the direction of a side surface (here, the first surface s1) of the semiconductor base 10. The capacitive portion 30 has a multilayer structure that includes at least a dielectric layer d1 that is disposed along the side surface, and a conductive layer m1 and a conductive layer m2 that face each other with the dielectric layer d1 interposed therebetween in the thickness direction of the dielectric layer d1.

According to the present embodiment, as for the capacitive portion 30, the conductive layer m1, the dielectric layer d1, the conductive layer m2, a dielectric layer d2, and a conductive layer m3 are stacked in this order. The dielectric layer d1 and the two conductive layers m1 and m2 that sandwich the dielectric layer d1 form a first capacitance Ca1. The dielectric layer d2 and the two conductive layers m2 and m3 that sandwich the dielectric layer d2 form a second capacitance Ca2.

The number of stacks of the multilayer structure of the capacitive portion 30 is not particularly limited, provided that the multilayer structure of the capacitive portion 30 includes one or multiple sets (two sets in FIG. 2) of capacitance formation structures each of which consists of a conductive layer/a dielectric layer/a conductive layer. For example, the capacitive portion 30 has a structure in which one or more sets of dielectric layers and conductive layers are stacked in turn on the conductive layer m1.

The dielectric layers d1 and d2 are composed of an insulating material. For example, the dielectric layers d1 and d2 may be SiO₂ films, HfO₂ films, or AlO films. For example, the thicknesses of the dielectric layers d1 and d2 are 10 nm. The conductive layers m2 and m3 contain a conductive material. For example, the conductive layers m2 and m3 may be TiN films (for example, a thickness of 20 nm) or polysilicon films (for example, a thickness of 1000 nm).

In the example illustrated in FIG. 2, the conductive layer m1 includes the low-resistance portion 14 of the semiconductor base 10. In the case where the semiconductor base 10 includes no low-resistance portions exposed from inner surfaces of the trench portions 16, the conductive layer m1 may be a conductive film that is additionally formed on the first surface s1 as in the conductive layers m2 and m3.

At least a part of the capacitive portion 30 is located inside the trench portions 16. Consequently, an effective area of the capacitive portion 30 can be increased. According to the present embodiment, the capacitive portion 30 is formed along the first surface s1 having the trench portions 16 and extends to inner portions of the trench portions 16 and to portions of the first surface s1 that are located around the trench portions 16.

The electrode layers 51 and 52 contain a conductive material. For example, the electrode layers 51 and 52 are metal layers such as Al or Cu layers. The electrode layers 51 and 52 are electrically connected to the capacitive portion 30. According to the present embodiment, the electrode layer 51 is electrically connected to the conductive layers m1 and m3. That is, the electrode layer 51 also functions as a connection electrode that electrically connects the multiple conductive layers m1 and m3 that are included in the capacitive portion 30. The electrode layer 52 is electrically connected to the conductive layer m2. As illustrated in FIG. 3, such connection enables the first capacitance Ca1 and the second capacitance Ca2 to be connected in parallel.

In the example illustrated in FIG. 2, the electrode layer 51 extends from the first surface s1 of the semiconductor base 10 in the direction of the lower surface 11. The electrode layer 52 extends from the first surface s1 of the semiconductor base 10 in the direction of the upper surface 12. The electrode layers 51 and 52 may extend in a substantially L-shape from the first surface s1 to the lower surface 11 or the upper surface 12 in a side view when viewed in the Y-direction.

The electrode layers 51 and 52 may include portions that are exposed from a surface of the semiconductor device 100 and that function as external terminals. In this example, a portion of the electrode layer 51 that forms the lower surface of the semiconductor device 100 and a portion of the electrode layer 52 that forms an upper surface of the semiconductor device 100 can function as the external terminals.

The insulating layer 41 is composed of an insulating material. The insulating layer 41 covers at least a part of the capacitive portion 30. According to the present embodiment, the insulating layer 41 is disposed between the low-resistance portion 14 of the semiconductor base 10 and the electrode layers 51 and 52 and between the capacitive portion 30 and the electrode layers 51 and 52.

For example, the insulating layer 41 includes a side portion that is disposed in the direction of the first surface s1 of the semiconductor base 10 and that covers the capacitive portion 30, a lower portion that is disposed in the direction of the lower surface 11 and that covers the low-resistance portion 14, and an upper portion that is disposed in the direction of the upper surface 12 and that covers the low-resistance portion 14. The insulating layer 41 (here, a side portion of the insulating layer 41) includes a first opening portion 411 from which a portion of the low-resistance portion 14 that is the conductive layer m1 is exposed, a second opening portion 412 from which a portion of the conductive layer m3 is exposed, and a third opening portion 413 from which a portion of the conductive layer m2 is exposed. The electrode layer 51 is formed on the insulating layer 41, in the first opening portion 411, and in the second opening portion 412. The electrode layer 51 is electrically connected to the conductive layer m1 in the first opening portion 411 (a first joint 511) and is electrically connected to the conductive layer m3 in the second opening portion 412 (a second joint 512). The electrode layer 52 is formed on the insulating layer 41 and in the third opening portion 413 and is electrically connected to the conductive layer m2 in the third opening portion 413 (a third joint 521).

### Method of Manufacturing Semiconductor Device

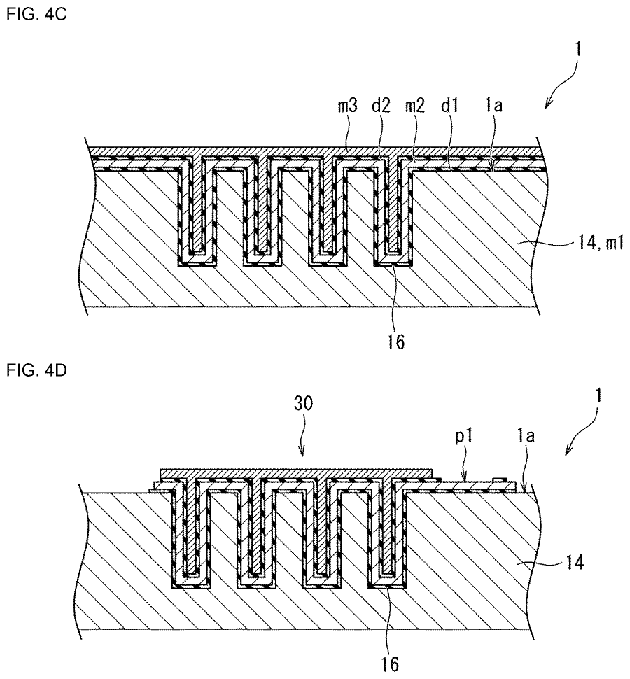

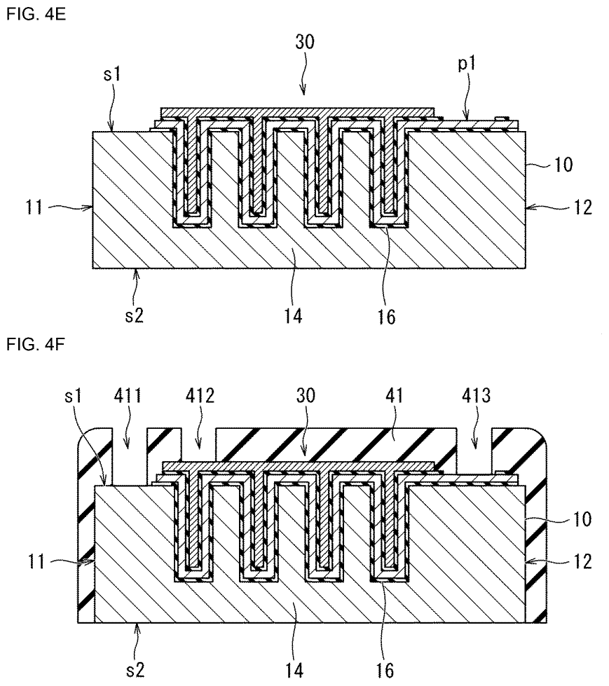

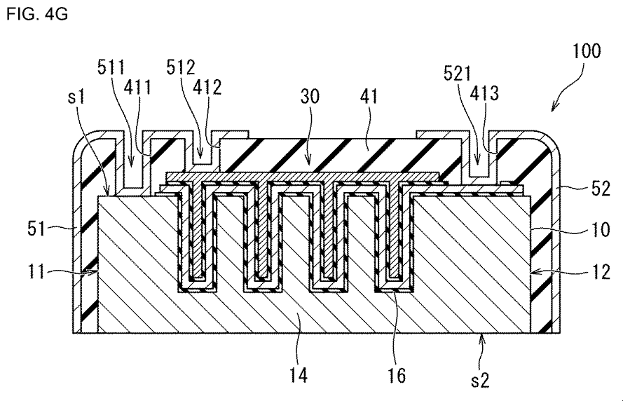

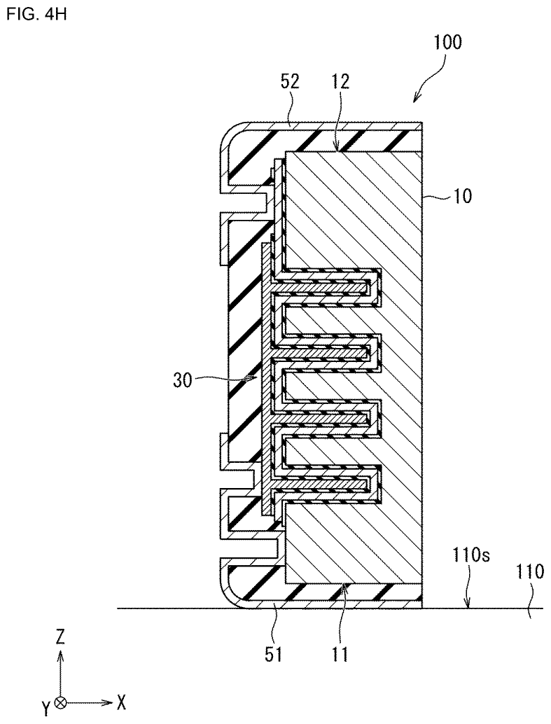

An example of a method of manufacturing the semiconductor device 100 will now be described. FIG. 4A to FIG. 4G are schematic sectional views of processing that illustrate the method of manufacturing the semiconductor device. FIG. 4H is a schematic sectional view of processing illustrating an example of a state in which the semiconductor device in FIG. 1 is mounted.

### Preparation of Semiconductor Substrate

As illustrated in FIG. 4A, a conductive semiconductor substrate (here, a conductive Si substrate) that includes the low-resistance portion 14 is first prepared as a semiconductor substrate 1. An example of the conductive Si substrate is a Si substrate that is doped with impurities for providing n-type or p-type conductivity.

### Formation of Trench Portion

Subsequently, as illustrated in FIG. 4B, the trench portions 16 are formed on a main surface 1a of the semiconductor substrate 1. The main surface 1a corresponds to the first surface s1 of the semiconductor base 10 illustrated in FIG. 1. Here, a hard mask is formed on the main surface 1a, and the hard mask is patterned. Subsequently, the hard mask is used as an etching mask, and deep silicon etching (Bosch process) is performed. Subsequently, the hard mask is removed from the main surface 1a. A method of forming the trench portions 16 is not particularly limited to the above method.

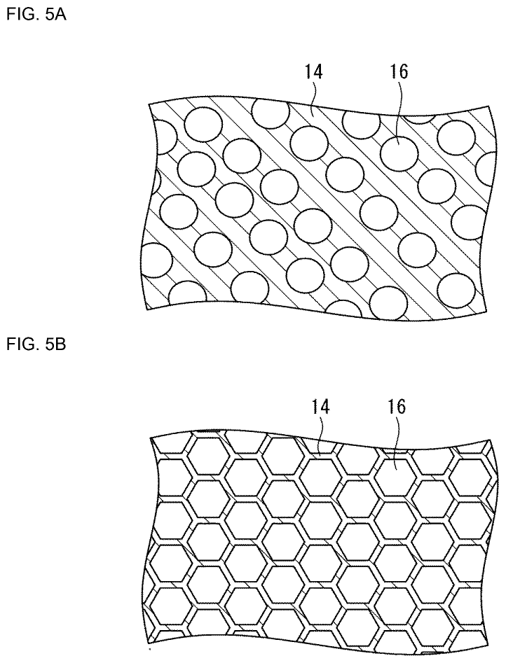

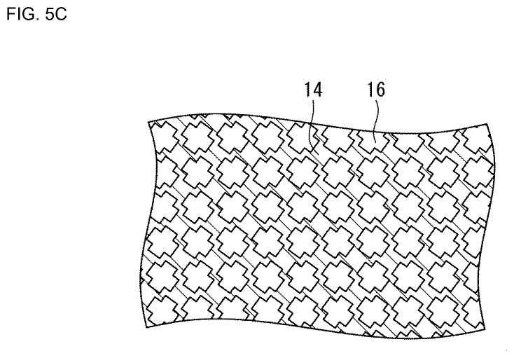

FIG. 5A to FIG. 5C are plan views of examples of the main surface 1a of the semiconductor substrate 1 on which the trench portions 16 are formed. As illustrated, the multiple openings of the trench portions 16 are spaced from each other on the main surface 1a. The trench portions 16 are regularly or randomly arranged on the main surface 1a. The shapes of the openings of the trench portions 16 are not particularly limited. For example, the shapes of the openings may be circular shapes as illustrated by way of example in FIG. 5A, polygonal shapes such as hexagonal shapes as illustrated by way of example in FIG. 5B, or tetrapot shapes as illustrated by way of example in FIG. 5C. Alternatively, a groove-shaped trench portion that extends in a direction may be aligned over the main surface 1a, although this is not illustrated. The total of the inner surface areas of the trench portions 16 can be increased due to, for example, the depths, planar shapes, and number of the trench portions 16.

### Formation of Capacitive Portion

Subsequently, as illustrated in FIG. 4C, dielectric layers and conductive layers are deposited in turn over the main surface 1a (including the inner portions of the trench portions 16), and consequently, the multilayer structure is formed. Here, the dielectric layer d1, the conductive layer m2, the dielectric layer d2, and the conductive layer m3 are deposited in this order. For example, the dielectric layers d1 and d2 may be formed by using a CVD (Chemical Vapor Deposition) method. The conductive layers m2 and m3 may be formed by using a sputtering method. Polysilicon films may be formed as the conductive layers m2 and m3. In this case, after polysilicon films are deposited, the polysilicon films may be doped with impurities for providing the conductivity, and consequently, the resistivity of the polysilicon films may be decreased.

Subsequently, as illustrated in FIG. 4D, the conductive layers and the dielectric layers are etched in order from the upper layer. Here, the conductive layer m3 is etched by using photolithography. Subsequently, the dielectric layer d2, the conductive layer m2, and the dielectric layer d1 are etched in this order by using photolithography. In the dielectric layer d2, an opening portion p1 from which a portion of the conductive layer m2 located below is exposed is formed. The dielectric layer d1 is removed, and consequently, a part of the low-resistance portion 14 is exposed. In this way, the capacitive portion 30 is formed.

### Dicing of Semiconductor Substrate

Subsequently, as illustrated in FIG. 4E, a back surface of the semiconductor substrate 1 is ground and diced (divided). Consequently, the semiconductor base 10 that has a predetermined size is acquired. According to the present embodiment, a surface s2 of the semiconductor substrate 1 that is ground is the second surface of the semiconductor base 10. The cut surfaces 11 and 12 that are cut in the thickness direction of the semiconductor substrate 1 by dicing are the lower surface 11 and the upper surface 12 of the semiconductor base 10.

### Formation of Insulating Layer

Subsequently, as illustrated in FIG. 4F, the insulating layer 41 is formed on the first surface s1 on which the capacitive portion 30 of the semiconductor base 10 is formed and on the surfaces 11 and 12 that are the cut surfaces, for example, in a manner in which an insulating material is deposited by using, for example, a spray deposition method. Subsequently, a side portion of the insulating layer 41 that is located on the first surface s1 is patterned (for example, dry etching) by using, for example, a photolithography method. Consequently, the first opening portion 411 from which the low-resistance portion 14 of the semiconductor base 10 is exposed, the second opening portion 412 from which a portion of the conductive layer m3 is exposed, and the third opening portion 413 from which a portion of the conductive layer m2 is exposed are formed on the insulating layer 41.

### Formation of Electrode Layer

Subsequently, as illustrated in FIG. 4G, the electrode layers 51 and 52 are formed. Here, electrode conductive films are first formed on the insulating layer 41 and in the first to third opening portions 411 to 413. Subsequently, the electrode conductive films are patterned (etched) by using, for example, photolithography. Consequently, the electrode layer 51 that is in contact with the low-resistance portion 14 in the first opening portion 411 and that is in contact with the conductive layer m3 in the second opening portion 412, and the electrode layer 52 that is in contact with the conductive layer m2 in the third opening portion 413 are formed from the electrode conductive films. In this way, the semiconductor device 100 is manufactured.

A method of forming the layers in the semiconductor device 100 and a formation order are not limited to the example described above. For example, in the case where the insulating layers and the electrode layers are formed only on a main surface of the semiconductor substrate, the semiconductor substrate may be diced after the electrode layers are formed.

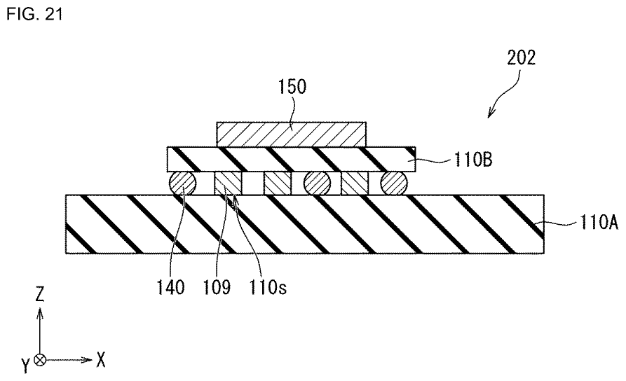

When the semiconductor device 100 is mounted on the mounting substrate, as illustrated in FIG. 4H, the semiconductor device 100 is mounted on a mounting substrate 110 such that the lower surface 11 of the semiconductor base 10 faces a mounting surface 110s. The semiconductor device 100 may be disposed between two mounting substrates. In this case, the lower surface 11 and the upper surface 12 of the semiconductor base 10 face the respective mounting surfaces of the mounting substrates (see FIG. 21).

### Effects

The semiconductor device 100 according to the present embodiment includes the semiconductor base 10 that has the lower surface 11 that is to face the mounting surface, the upper surface 12 that is spaced from the lower surface 11 in the height direction, and a side surface that connects the upper surface and the lower surface to each other, and the capacitive portion 30 that is disposed in the direction of the side surface of the semiconductor base 10. The capacitive portion 30 has the multilayer structure that includes at least the first dielectric layer d1 that is disposed along the side surface, and the first conductive layer m1 and the second conductive layer m2 that face each other with the first dielectric layer d1 interposed therebetween. At least a part of the capacitive portion 30 is located inside the trench portions 16 that are formed on the side surface of the semiconductor base 10.

With the structure described above, the capacitive portion 30 is disposed in the direction of the side surface of the semiconductor base 10, and accordingly, the area of the capacitive portion 30 can be increased by increasing the height (that is, the height of the side surface) of the semiconductor base 10 from the lower surface 11 to the upper surface 12. Accordingly, the area of the lower surface 11 that is the mounting area is inhibited from increasing, and the electrostatic capacity of the capacitive portion 30 can be increased. In the present specification, the “area of the capacitive portion” means the area of the capacitive portion when viewed in the normal direction (here, the X-direction) to the surface on which the capacitive portion is formed.

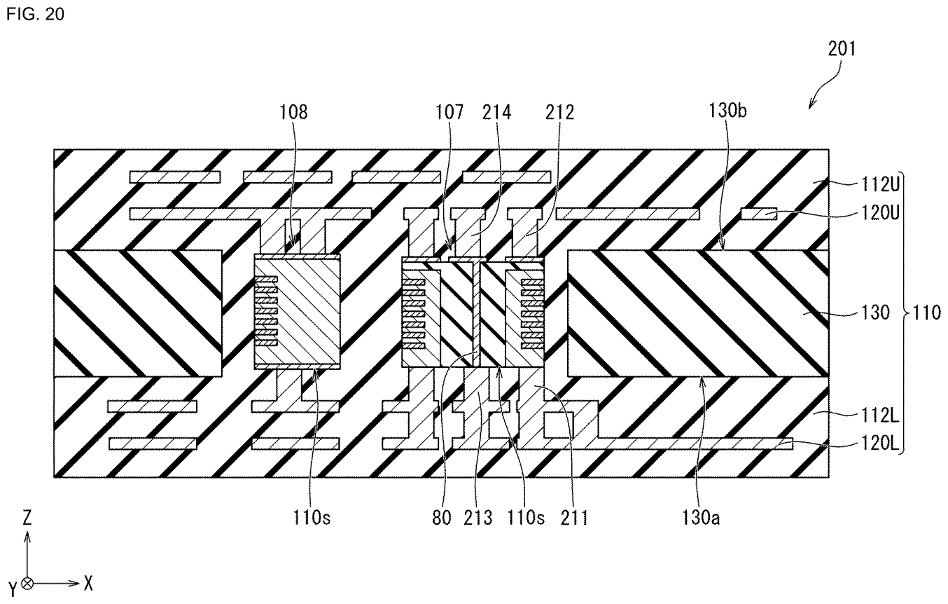

With the structure described above, the height of the semiconductor base 10 can be set with a high degree of freedom. Accordingly, the height of the semiconductor device 100 from the mounting surface (chip thickness) can be set depending on the use of the semiconductor device 100. For example, when the semiconductor device 100 is contained in a circuit substrate, setting the chip thickness at about the degree of the thickness of a core material makes the semiconductor device 100 easy to mount on the circuit substrate (see FIG. 20). When the chip thickness is greater than that in an existing case, the semiconductor device 100 can be used as a bridge for mutual connection between substrates (see FIG. 21).

An existing semiconductor device includes a trench portion and a capacitive portion on an upper surface of a semiconductor base. For this reason, the maximum width of the semiconductor base is greater than the height of the semiconductor base depending on the area of the capacitive portion (a trench formation surface). The height (the thickness) of the semiconductor base from the mounting surface to the upper surface is restricted by, for example, the thickness of a Si substrate from which the semiconductor base is cut and a trench processing depth and is accordingly about, for example, 0.725 μm or less.

According to the present embodiment, however, the height of the semiconductor base 10 from the lower surface 11 to the upper surface 12 (the height in the Z-direction) can be set with a high degree of freedom depending on, for example, the dicing width of the semiconductor substrate. Accordingly, the height of the semiconductor base 10 can be set at more than 0.725 μm, for example, 1.0 μm or more. The semiconductor device 100 that has a column shape elongated in the Z-direction can be provided in a manner in which the height of the semiconductor base 10 is set at more than the maximum width of the lower surface 11 of the semiconductor base 10. Accordingly, the mounting area is decreased, and the capacitance can be further increased.

As for the semiconductor device 100 according to the present embodiment, the depth direction from the openings of the trench portions 16 is parallel with the mounting surface. With this structure, multiple trench portions 13 can be more densely arranged in the Z-direction on a side surface of the semiconductor base 10. Accordingly, the mounting area is decreased, and the capacitance can be further increased.

The semiconductor device 100 according to the present embodiment further includes a pair of external terminals that are electrically connected to the capacitive portion 30. One of the pair of external terminals (such as the electrode layer 51) is located in the direction of the lower surface 11 of the semiconductor base 10, and the other of the pair of external terminals (such as the electrode layer 52) is located in the direction of the upper surface 12 of the semiconductor base 10. With this structure, the external terminal is located in the direction of the lower surface 11 of the semiconductor base 10, and accordingly, the semiconductor device 100 is easily mounted on the mounting substrate such that the lower surface 11 of the semiconductor base 10 faces the mounting surface. The external terminals are located in the direction of the lower surface 11 and the direction of the upper surface 12 of the semiconductor base 10. Accordingly, the semiconductor device 100 is easily contained in a circuit substrate, and the semiconductor device 100 is easily mounted on two mounting substrates that are disposed above and below the semiconductor device 100.

In the example illustrated in FIG. 2, portions of the electrode layers 51 and 52 that are exposed from the lower surface and the upper surface of the semiconductor device 100 function as the external terminals. The external terminals may be outer electrodes that are additionally provided on the electrode layers. A part of the low-resistance portion of the semiconductor base may be exposed from a surface of the semiconductor device 100 and may be used as an external terminal.

As for the semiconductor device 100 according to the present embodiment, one or both of the pair of the electrode layers 51 and 52 that are electrically connected to the capacitive portion 30 extend in the direction from a side surface (the first surface s1) of the semiconductor base 10 to the lower surface 11 or the upper surface 12. The semiconductor device 100 is easily mounted on the mounting substrate in a manner in which the electrode layers 51 and 52 are drawn out from the first surface s1 in the direction of the lower surface 11 and/or in the direction of the upper surface 12. In particular, the semiconductor device 100 can be easily mounted (embedded) in a circuit substrate or mounted between two mounting substrates.

The semiconductor device 100 according to the present embodiment includes the electrode layer 51 that is electrically connected to the multiple conductive layers m1 and m3 in the capacitive portion 30. With this structure, the multiple capacitances Ca1 and Ca2 that are included in the capacitive portion 30 can be connected in parallel. Accordingly, the capacitance can be further increased.

As for the semiconductor device 100 according to the present embodiment, for example, the thicknesses of the conductive layers m1 to m3 that are capacitive electrodes are equal to or more than twice the thicknesses of the dielectric layers d1 and d2. With this structure, the capacitance can be increased in a manner in which the thicknesses of the dielectric layers d1 and d2 are decreased. Power loss (such as copper loss) due to a resistance component in a conductive material can be reduced, and the Q value of the capacitive portion 30 can be increased in a manner in which the thicknesses of the conductive layers m1 to m3 are increased.

As for an existing semiconductor device, an area required for forming a capacitive portion increases with an increase in the thickness of each conductive layer of the capacitive portion, and accordingly, a chip area and a mounting area increase in some cases. For this reason, the thickness of each conductive layer is decreased to, for example, the same degree as the thickness of a dielectric layer. According to the present embodiment, however, the height of the semiconductor base 10 is increased, and consequently, the area for forming the capacitive portion 30 can be increased. Accordingly, the conductive layers m1 to m3 that are included in the capacitive portion 30 can be formed so as to have desired thicknesses.

As for the semiconductor device 100 according to the present embodiment, a base that includes the low-resistance portion 14 that is composed of a low-resistance semiconductor and that is conductive is used as the semiconductor base 10. With this structure, the low-resistance portion 14 can be used as the capacitive electrode (here, the conductive layer m1) of the capacitive portion 30. Accordingly, the thickness of the multilayer structure of the capacitive portion 30 can be decreased, and the size of the semiconductor device 100 can be decreased. The number of film formation processes when the capacitive portion 30 is formed can be decreased.

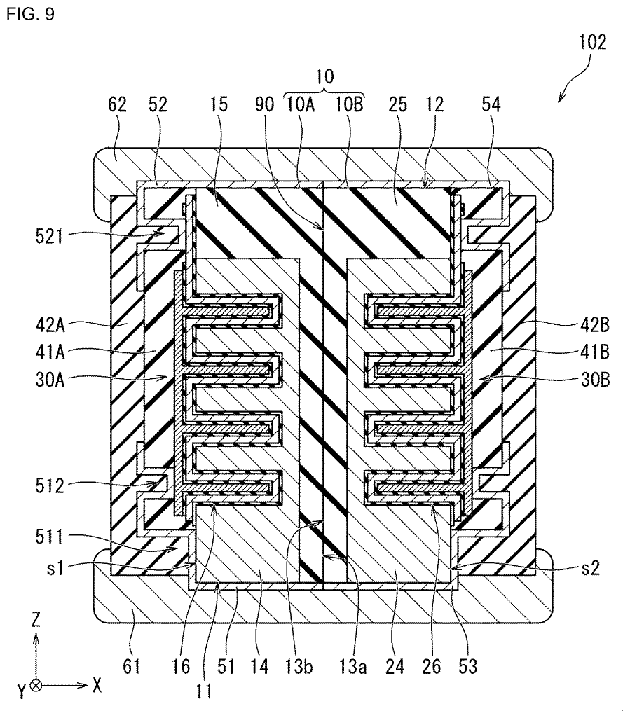

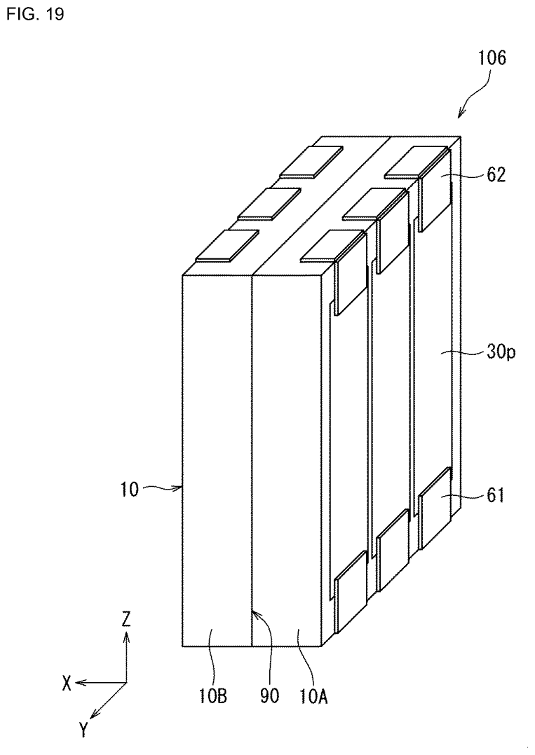

The low-resistance portion 14 can be exposed from a surface of the semiconductor device 100 and can be used as an external terminal that electrically connects the semiconductor device 100 and the outside (see FIG. 20). The low-resistance portion 14 can be used also for electrical connection between the conductive layers m1 and m3 that are included in the capacitive portion 30, for electrical connection of two capacitive portions (see FIG. 9) that are formed on different surfaces, or for electrical connection of multiple capacitor portions (see FIG. 19) that are spaced from each other in parallel. The use of the low-resistance portion 14 enables an electrode layer (or an outer electrode) for the connection described above to be omitted and enables the size and costs of the semiconductor device 100 to be decreased.

The structure of the semiconductor device according to the present embodiment is not limited to the structure illustrated in FIG. 1 to FIG. 3. The semiconductor base is not limited to a low-resistance base and may be a high-resistance base that includes no low-resistance portion. The semiconductor base may include a low-resistance portion and an insulating high-resistance portion that has an electric resistance higher than that of the low-resistance portion. The capacitive portion may be disposed in the direction of a side surface of the semiconductor base, and the trench portions and the capacitive portion may be disposed on one or two or more surfaces of four surfaces that are included in the side surfaces, for example, in the case where the semiconductor base has a rectangular cuboid shape.

In a circuit illustrated in FIG. 3, the two capacitances Ca1 and Ca2 are connected in parallel but may be connected in series. An electrode structure and the structures and positions of joints between the capacitive portion and the electrode layers, for example, are not particularly limited to an illustrated example.

### Modification

A semiconductor device according to a modification differs from the semiconductor device 100 illustrated in FIG. 1 to FIG. 3 in further including a backside electrode layer.

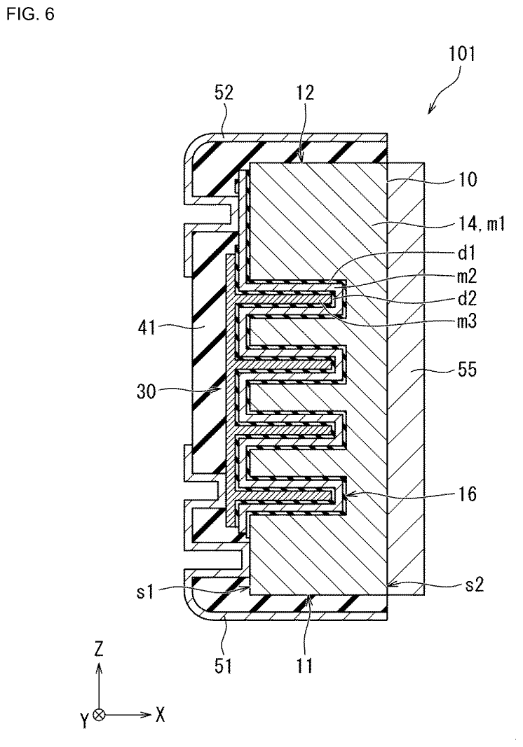

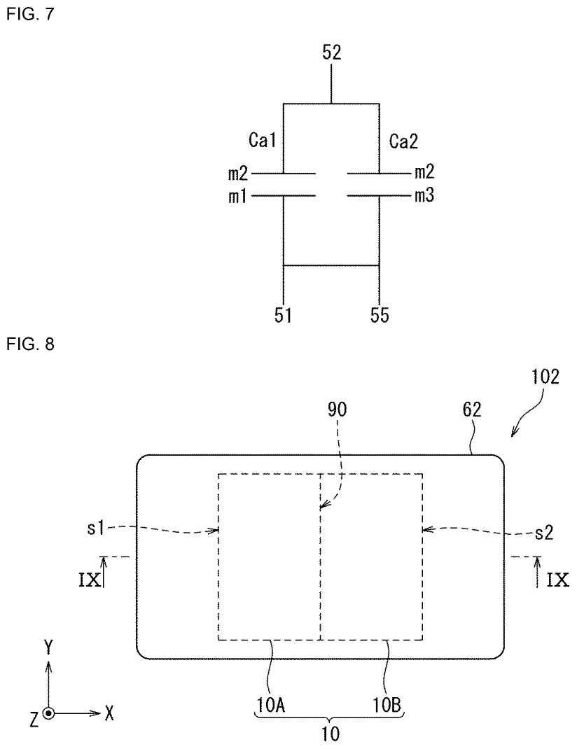

FIG. 6 is a schematic sectional view of the semiconductor device according to the modification. FIG. 7 schematically illustrates an example of a circuit structure in the semiconductor device in FIG. 6.

As illustrated in FIG. 6, a semiconductor device 101 according to a modification further includes a backside electrode layer 55 in the direction of the second surface s2 of the semiconductor base 10. The material of the backside electrode layer 55 is not particularly limited and may be, for example, the same material as that of the electrode layers 51 and 52.

For example, the backside electrode layer 55 is electrically connected to at least one conductive layer (here, the conductive layer m1) of the capacitive portion 30. In an example illustrated in FIG. 6, the backside electrode layer 55 is connected to the low-resistance portion 14 that doubles as the conductive layer m1 of the capacitive portion 30 at the second surface s2. With this structure, as illustrated in FIG. 7, the backside electrode layer 55, the electrode layer 51, and the conductive layers m1 and m3 of the capacitive portion 30 are electrically connected to each other. In FIG. 6, the backside electrode layer 55 is formed over the whole of the second surface s2, but may be disposed only on a portion of the second surface s2.

The semiconductor device 101 according to the present modification enables noise to be reduced, for example, in a manner in which the electrode layer 52 and the backside electrode layer 55 are grounded. In addition, ESL (parasitic inductance) can be reduced. In addition, the backside electrode layer 55 can be used as an input portion that receives a signal from the outside or an output portion that outputs a signal to the outside. Accordingly, the degree of freedom of design can be increased.

In the example illustrated in FIG. 6 and FIG. 7, the backside electrode layer 55 is electrically connected to the capacitive portion 30. However, the backside electrode layer 55 may be electrically isolated from the capacitive portion 30 and the electrode layers 51 and 52. In this case, the backside electrode layer 55 serves as an electrode in a floating state and can be used as a shield. For example, the semiconductor base 10 may include an insulating high-resistance portion in the direction of the second surface s2, and the backside electrode layer 55 may be in contact with the high-resistance portion.

### Second Embodiment

A semiconductor device according to a second embodiment differs from the semiconductor device 100 (FIG. 1) according to the first embodiment in including a capacitive portion in the direction of the second surface of the semiconductor base. Differences from the semiconductor device according to the first embodiment will be mainly described below, and a duplicated description is appropriately omitted.

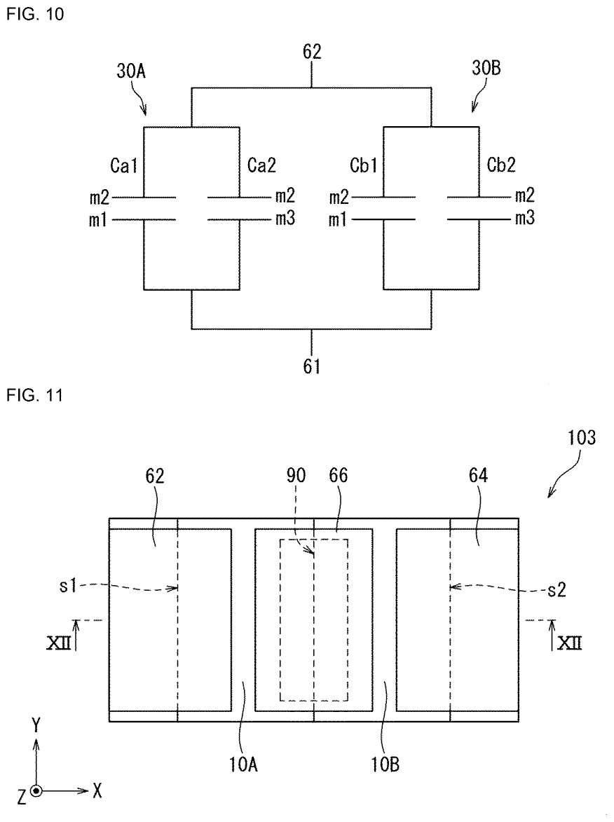

FIG. 8 is a schematic top view of the semiconductor device according to the second embodiment. FIG. 9 is a schematic sectional view of the semiconductor device taken along line IX-IX in FIG. 8. FIG. 10 schematically illustrates an example of a circuit structure in the semiconductor device in FIG. 8.

For example, a semiconductor device 102 has a substantially rectangular cuboid shape. For example, the height (thickness) h of the semiconductor device 102 is 1.0 mm, the width wx in the X-direction is 1.0 mm, and the width wy in the Y-direction is 0.5 mm. For example, the mounting area is 1.0 mm×0.5 mm.

As illustrated in FIG. 9, the semiconductor device 102 includes the semiconductor base 10, a first capacitive portion 30A, a second capacitive portion 30B, insulating layers 41A and 41B, protection layers 42A and 42B, the electrode layers 51 and 52, electrode layers 53 and 54, and outer electrodes 61 and 62.

The semiconductor base 10 includes the low-resistance portion 14 and a low-resistance portion 24 that are conductive and high-resistance portions 15 and 25 that have an electric resistance higher than those of the low-resistance portions 14 and 24 (here, insulating). For example, the low-resistance portions 14 and 24 are Si layers that are doped with impurities for providing the conductivity. For example, the high-resistance portions 15 and 25 are high-resistance Si layers or SiO₂ layers. In an example illustrated in FIG. 9, the low-resistance portion 14 is exposed from the first surface s1 and the lower surface 11. The low-resistance portion 24 is exposed from the second surface s2 and the lower surface 11. The high-resistance portions 15 and 25 are exposed from the upper surface 12. At least parts of the high-resistance portions 15 and 25 are electrically isolated from the low-resistance portion 14 and the low-resistance portion 24.

For example, the semiconductor base 10 includes a first base 10A that includes the low-resistance portion 14 and the high-resistance portion 15 and a second base 10B that includes the low-resistance portion 24 and the high-resistance portion 25. The first base 10A has a back surface 13a that is spaced from the first surface s1 in a first direction (here, the X-direction) intersecting with the first surface s1. The high-resistance portion 15 is exposed from the back surface 13a. The second base 10B has a back surface 13b that is spaced from the second surface s2 in the first direction (the X-direction). The high-resistance portion 25 is exposed from the back surface 13b. The back surface 13a of the first base 10A and the back surface 13b of the second base 10B are bonded to each other by, for example, direct bonding and form a bonding surface 90. In some cases, the bonding surface 90 is invisible.

The semiconductor base 10 includes at least one trench portion (referred to as a “first trench portion” in some cases) 16 that has an opening in the first surface s1 and at least one trench portion (referred to as a “second trench portion” in some cases) 26 that has an opening in the second surface s2. In the example illustrated in FIG. 9, the trench portions 16 are formed in the low-resistance portion 14, and the trench portions 26 are formed in the low-resistance portion 24. That is, the low-resistance portions 14 and 24 are exposed from inner surfaces of the trench portions 16 and 26.

The first capacitive portion 30A is located in the direction of the first surface s1 of the semiconductor base 10. At least a part of the first capacitive portion 30A is located inside the trench portions 16. The second capacitive portion 30B is located in the direction of the second surface s2. At least a part of the second capacitive portion 30B is located inside the trench portions 26. In the example illustrated in FIG. 9, the first capacitive portion 30A extends to inner portions of the trench portions 16 and portions of the first surface s1 that are located around the trench portions 16. Similarly, the second capacitive portion 30B extends to inner portions of the trench portions 26 and portions of the second surface s2 that are located around the trench portions 26.

The first capacitive portion 30A and the second capacitive portion 30B have a multilayer structure that has one or more sets (here, two sets) of capacitance formation structures each of which consists of a conductive layer/a dielectric layer/a conductive layer as in the capacitive portion 30 (FIG. 2) according to the first embodiment.

In the example illustrated in FIG. 9, the first capacitive portion 30A includes the first capacitance Ca1 that includes the dielectric layer d1 and the conductive layers m1 and m2, and the second capacitance Ca2 that includes the dielectric layer d2 and the conductive layers m2 and m3. For example, the conductive layer m1 of the first capacitive portion 30A includes the low-resistance portion 14. The second capacitive portion 30B includes a first capacitance Cb1 that includes a dielectric layer d1 and conductive layers m1 and m2 and a second capacitance Cb2 that includes a dielectric layer d2 and conductive layers m2 and m3. For example, the conductive layer m1 of the second capacitive portion 30B includes the low-resistance portion 24. For example, the first capacitive portion 30A and the second capacitive portion 30B have the same multilayer structure. The electrostatic capacity C1 (the equivalent capacitance of the capacitances Ca1 and Ca2 that are connected in parallel) of the first capacitive portion 30A is equal to the electrostatic capacity C2 (the equivalent capacitance of the capacitances Cb1 and Cb2 that are connected in parallel) of the second capacitive portion 30B.

The electrode layers 51 and 52 are electrically connected to the first capacitive portion 30A. For example, the electrode layers 51 and 52 have the same structure as the electrode layers 51 and 52 (FIG. 2) according to the first embodiment. However, the structure of the first joint 511 that electrically connects the electrode layer 51 and the conductive layer m1 (the low-resistance portion 14) to each other is changed. As for the first joint 511 of the semiconductor device 102, the electrode layer 51 extends to the low-resistance portion 14 that is exposed from the first surface s1 and the lower surface 11.

The electrode layers 53 and 54 are electrically connected to the second capacitive portion 30B. The structures of joints between the electrode layers 53 and 54 and the second capacitive portion 30B are the same as the structures of the joints 511, 512, and 521 between the electrode layers 51 and 52 and the first capacitive portion 30A.

According to the present embodiment, the electrode layers 51 and 53 are electrically connected to each other. The electrode layers 52 and 54 are electrically connected to each other. This enables the four capacitances Ca1, Ca2, Cb1, and Cb2 to be connected in parallel as illustrated in FIG. 10.

In the example illustrated in FIG. 9, the electrode layer 51 extends in the direction from the first surface s1 of the semiconductor base 10 to the lower surface 11. The electrode layer 53 extends in the direction from the second surface s2 of the semiconductor base 10 to the lower surface 11. The electrode layers 51 and 53 are electrically connected to each other in the direction of the lower surface 11. The electrode layers 51 and 53 may be directly connected to each other or may be electrically connected to each other with the outer electrode 61 interposed therebetween. Similarly, the electrode layer 52 extends in the direction from the second surface s2 of the semiconductor base 10 to the upper surface 12. The electrode layer 54 extends in the direction from the second surface s2 of the semiconductor base 10 to the upper surface 12. The electrode layers 52 and 54 are electrically connected to each other in the direction of the upper surface 12. The electrode layers 52 and 54 may be directly connected to each other or may be electrically connected to each other with the outer electrode 62 interposed therebetween.

The insulating layer 41A is disposed on the first surface s1 of the first base 10A so as to cover the capacitive portion 30A. The insulating layer 41B is disposed on the second surface s2 of the second base 10B so as to cover the capacitive portion 30B. In the example illustrated in FIG. 9, the insulating layer 41A is disposed between the low-resistance portion 14 and the electrode layers 51 and 52 and between the capacitive portion 30A and the electrode layers 51 and 52. The insulating layer 41B is disposed between the low-resistance portion 24 and the electrode layers 53 and 54 and between the capacitive portion 30B and the electrode layers 53 and 54.

The insulating layers 41A and 41B include opening portions from which the conductive layers m1 to m3 of the capacitive portions 30A and 30B corresponding thereto are exposed as in the insulating layer 41 (FIG. 2) according to the first embodiment. According to the present embodiment, however, the insulating layers 41A and 41B do not extend to the lower surface 11 or the upper surface 12 of the semiconductor base 10. Consequently, the low-resistance portions 14 and 24 are exposed from the lower surface 11 of the semiconductor base 10. The electrode layers 51 and 53 are disposed on the exposed parts of the low-resistance portions 14 and 24, and consequently, the area of connection between the electrode layers 51 and 53 and the low-resistance portions 14 and 24 can be increased. In addition, the high-resistance portions 15 and 25 enable the low-resistance portions 14 and 24 and the electrode layers 52 and 54 to be electrically isolated from each other even though the insulating layer 41 does not extend to the upper surface 12 of the semiconductor base 10.

The protection layers 42A and 42B are composed of an insulating material. The protection layers 42A and 42B may be organic resin layers such as polyimide, phenol, or epoxy layers, or inorganic insulating layers such as SiO₂, TiO₂, or SiN layers. The protection layers 42A and 42B may be composed of a composite material of an organic material and an inorganic material.

The protection layer 42A is disposed in the direction of the first surface s1 of the semiconductor base 10 so as to cover the first capacitive portion 30A with the insulating layer 41A interposed therebetween. The protection layer 42B is disposed in the direction of the second surface s2 of the semiconductor base 10 so as to cover the second capacitive portion 30B with the insulating layer 41B interposed therebetween. The electrode layers 51 and 53 are exposed from the protection layers 42A and 42B in the direction of the lower surface 11. The electrode layers 52 and 54 are exposed from the protection layers 42A and 42B in the direction of the upper surface 12.

The outer electrodes 61 and 62 contain a conductive material. Examples of the outer electrodes 61 and 62 are metal electrodes. The outer electrodes 61 and 62 may be multilayer conductive films that include multiple conductive films. The conductive films that are included in the multilayer conductive films, including catalyst layers, may be selected so as to have desired characteristics and may contain at least one metal element selected from, for example, Ni, Sn, Au, and Cu. For example, the outer electrodes 61 and 62 include multilayer conductive films (Ni/Sn or Ni/Cu) that include Ni films and Sn films or Cu films. For example, the outer electrodes 61 and 62 may be thicker than the electrode layers 51 to 54.

The outer electrodes 61 and 62 function as the external terminals of the semiconductor device 102. The outer electrode 61 is disposed outside the electrode layers 51 and 53 (on the opposite side of the electrode layers 51 and 53 from the semiconductor base 10) in the direction of the lower surface 11 of the semiconductor base 10. The outer electrode 61 is electrically connected to the exposed parts of the electrode layers 51 and 53 in the direction of the lower surface 11. In the example illustrated in FIG. 9, the outer electrode 61 covers a lower end portion of the protection layer 42A, the exposed parts of the electrode layers 51 and 53, and a lower end portion of the protection layer 42B.

The outer electrode 62 is disposed outside the electrode layers 52 and 54 (on the opposite side of the electrode layers 52 and 54 from the semiconductor base 10) in the direction of the upper surface 12 of the semiconductor base 10. The outer electrode 62 is electrically connected to the exposed parts of the electrode layers 52 and 54 in the direction of the upper surface 12. In the example illustrated in FIG. 9, the outer electrode 62 covers an upper end portion of the protection layer 42A, the exposed parts of the electrode layers 52 and 54, and an upper end portion of the protection layer 42B.

### Method of Manufacturing Semiconductor Device

An example of a method of manufacturing the semiconductor device 102 according to the present embodiment will be described. Differences from the method described according to the first embodiment will be mainly described below.

### Preparation of Semiconductor Substrate

Semiconductor substrates that include low-resistance portions and high-resistance portions are first prepared. For example, each low-resistance portion may be formed in a manner in which a predetermined region of a high-resistance semiconductor substrate (a high-resistance Si substrate) is doped with impurities for providing the conductivity by using, for example, a resist mask. Each high-resistance portion is a region of the high-resistance Si substrate in which no impurities are doped.

### Formation of Trench Portion and Capacitive Portion

Subsequently, trench portions are formed on a main surface of each semiconductor substrate as in the first embodiment. Subsequently, a multilayer structure that serves as a capacitive portion is formed, and an insulating layer that covers the capacitive portion is formed.

### Bonding of Substrate or Base

Subsequently, after the back surfaces of the semiconductor substrates that include the capacitive portions are bonded to each other, dicing is performed. Alternatively, after the semiconductor substrates that include the capacitive portions are diced, the back surfaces of the diced bases may be bonded to each other. The back surfaces of the semiconductor substrates or the bases are preferably polished before a bonding process. An example of a bonding method can be known direct bonding such as W2W (Wafer to Wafer bonding) or D2D (Die to Die bonding) but is not particularly limited thereto. In this way, a semiconductor base that includes the capacitive portions that are formed on both surfaces is acquired.

### Formation of Electrode Structure

Subsequently, electrode layers, protection layers, and outer electrodes are formed over the semiconductor base that includes the capacitive portions. An example of a method of forming the outer electrodes can be a known dip method or sputtering method but is not limited thereto. In this way, the semiconductor device 102 is manufactured.

### Effects

As for the semiconductor device 101 according to the present embodiment, the capacitive portions include the first capacitive portion 30A that is located in the direction of the first surface s1 of the semiconductor base 10 and the second capacitive portion 30B that is located in the direction of the second surface s2. At least a part of the first capacitive portion 30A is located inside the trench portions 16, and at least a part of the second capacitive portion 30B is located inside the trench portions 26. With this structure, the capacitive portions 30A and 30B are provided on the two surfaces s1 and s2 that are side surfaces of the semiconductor base 10, and consequently, the ratio of the areas of the capacitive portions to the mounting area can be further increased. Accordingly, the mounting area is inhibited from increasing, and the capacitance can be further increased.

The semiconductor device 102 according to the present embodiment further includes the outer electrodes 61 and 62 that are located outside the electrode layers 51 to 54 (opposite the semiconductor base 10). With this structure, the barrier properties of the semiconductor device 100 can be improved. The outer electrodes 61 and 62 that serve as the external terminals are formed in addition to the electrode layers 51 to 54 that are drawn out from the capacitive portions 30A and 30B to the lower surface 11 or the upper surface 12 of the semiconductor base 10, and this enables material and thickness appropriate to the use to be selected. For example, the use of a material that has high solder wettability for the outer electrodes 61 and 62 enables the bonding strength between the outer electrodes 61 and 62 and the mounting substrate to be further increased.

The structure of the semiconductor device according to the present embodiment is not limited to the structure illustrated in FIG. 8 to FIG. 10. For example, the shapes and arrangement of the low-resistance portions 14 and 24 and the high-resistance portions 15 and 25 in the semiconductor base 10 are not limited to an illustrated example. A method of bonding the bases 10A and 10B is not limited to direct bonding.

As for the semiconductor device 102 illustrated in FIG. 9, the semiconductor base 10 has a structure that includes two bonded bases, but the semiconductor base 10 may include a single base. Such a semiconductor device can be manufactured, for example, in a manner in which trench portions are formed in the direction of a main surface and in the direction of a back surface of a single semiconductor substrate, and capacitive portions are formed therein.

### First Modification

A semiconductor device according to a first modification differs from the semiconductor device 102 illustrated in FIG. 8 and FIG. 9 in further including a through electrode.

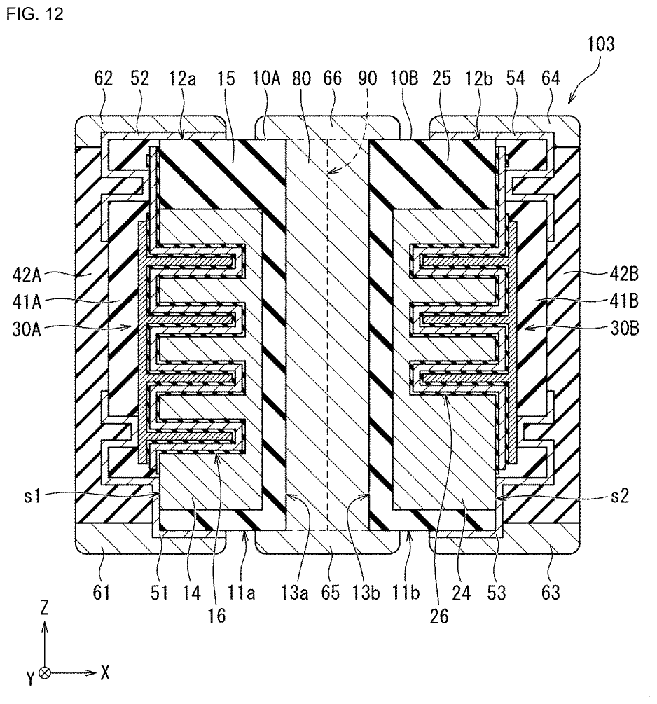

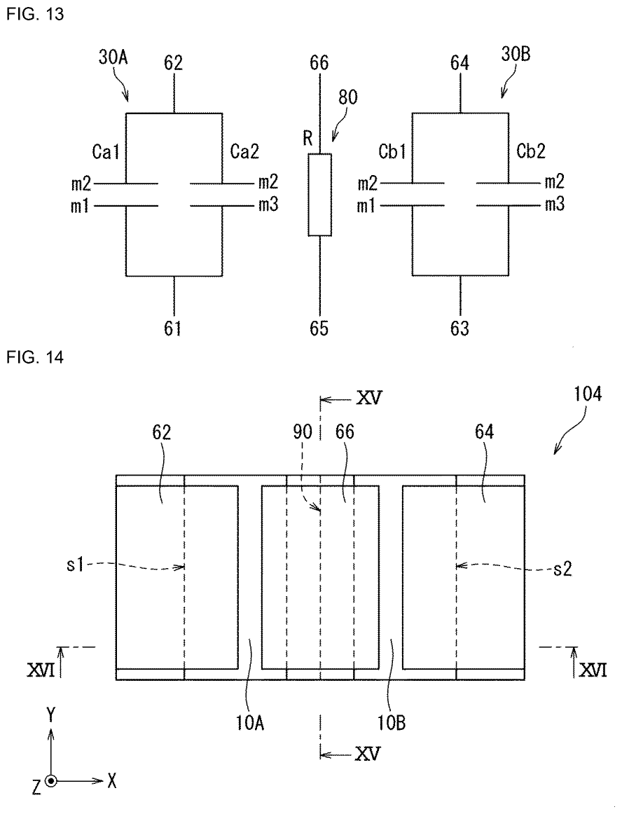

FIG. 11 is a schematic top view of the semiconductor device according to the first modification. FIG. 12 is a schematic sectional view taken along line XII-XII in FIG. 11. FIG. 13 schematically illustrates an example of a circuit structure in the semiconductor device in FIG. 11.

A semiconductor device 103 includes the semiconductor base 10 that includes the first base 10A and the second base 10B, the first capacitive portion 30A, the second capacitive portion 30B, a through electrode 80, the insulating layers 41A and 41B, the protection layers 42A and 42B, the electrode layers 51 to 54, the outer electrodes 61 and 62, outer electrodes 63 and 64, and through-electrode outer electrodes 65 and 66. The electrode layers 51 to 54 are electrically connected to the outer electrodes 61 to 64 corresponding thereto. Both end portions of the through electrode 80 are electrically connected to the through-electrode outer electrodes 65 and 66.

The first base 10A includes the low-resistance portion 14 and the high-resistance portion 15. The low-resistance portion 14 is exposed from the first surface s1. The high-resistance portion 15 is exposed from a lower surface 11a, an upper surface 12a, and the back surface 13a of the first base 10A. Similarly, the second base 10B includes the low-resistance portion 24 and the high-resistance portion 25. The low-resistance portion 24 is exposed from the second surface s2. The high-resistance portion 25 is exposed from a lower surface 11b, an upper surface 12b, and the back surface 13b of the second base 10B.

For example, the through electrode 80 is a metal electrode such as a Cu or Al electrode. For example, the thickness of the through electrode 80 in the X-direction is 1 μm or less. For example, the through electrode 80 is disposed between the first surface s1 and the second surface s2 of the semiconductor base 10 so as to extend through the semiconductor base 10 from the lower surface to the upper surface. For example, the through electrode 80 has a quadrangular prism shape that extends in the Z-direction. According to the present modification, the through electrode 80 is electrically isolated from the capacitive portions 30A and 30B.

The through electrode 80 may be located between the back surface 13a of the first base 10A and the back surface 13b of the second base 10B. In an example illustrated in FIG. 12, the back surface 13a of the first base 10A and the back surface 13b of the second base 10B are spaced from each other in the X-direction, and the through electrode 80 is disposed between the back surfaces 13a and 13b. The through electrode 80 may be disposed substantially over the whole of the back surface 13a or the back surface 13b when viewed in the X-direction. Alternatively, as illustrated by way of example in FIG. 11, the back surface 13a of the first base 10A and the back surface 13b of the second base 10B may be partly bonded to each other, and the through electrode 80 may be disposed in a recessed portion or recessed portions provided on a portion or portions (such as central portions) of one or both (here, both) of the back surfaces 13a and 13b.

The through electrode 80 can also function as a bonding layer that bonds the first base 10A and the second base 10B to each other. The through electrode 80 may be formed in a manner in which an electrode portion that is formed in the direction of the back surface 13a of the first base 10A and an electrode portion that is formed in the direction of the back surface 13b of the second base 10B are bonded to each other (for example, Cu—Cu bonding).

The through-electrode outer electrodes 65 and 66 contain a conductive material. For example, the through-electrode outer electrodes 65 and 66 can be formed by using the same material (such as Cu or Al) and the same method as the other outer electrodes 61 to 64.

The through-electrode outer electrode 65 is disposed in the direction of the lower surface of the semiconductor base 10 and is electrically connected to a lower end portion of the through electrode 80. The through-electrode outer electrode 66 is disposed in the direction of the upper surface of the semiconductor base 10 and is electrically connected to an upper end portion of the through electrode 80. The through-electrode outer electrodes 65 and 66 can be drawn out from the semiconductor device 103 to the outside and can be electrically connected to, for example, a wiring line on the circuit substrate. Accordingly, a signal/power can be provided through the through electrode 80 from the outside via the through-electrode outer electrodes 65 and 66.

The first capacitive portion 30A and the second capacitive portion 30B have different structures. Here, the capacitive portions 30A and 30B are configured such that the electrostatic capacity C1 (the equivalent capacitance of the capacitances Ca1 and Ca2 that are connected in parallel) of the first capacitive portion 30A and the electrostatic capacity C2 (the equivalent capacitance of the capacitances Cb1 and Cb2 that are connected in parallel) of the second capacitive portion 30B differ from each other. In an example illustrated in FIG. 12, the number of the trench portions 26 is smaller than the number of the trench portions 16, and consequently, an effective area of the second capacitive portion 30B is smaller than that of the first capacitive portion 30A. Accordingly, the electrostatic capacity C2 is less than the electrostatic capacity C1.

A structure for making the electrostatic capacities of the first capacitive portion 30A and the second capacitive portion 30B different from each other is not particularly limited. For example, the number of the trench portions, opening diameter (opening area), depth, and shape of each trench portion may differ between the first capacitive portion 30A and the second capacitive portion 30B. A multilayer number (the number of the dielectric layers) or the thickness of each dielectric layer may differ between the first capacitive portion 30A and the second capacitive portion 30B.

The electrode layers 51 to 54 are electrically connected to the capacitive portions 30A and 30B corresponding thereto as in the electrode layers 51 to 54 illustrated in FIG. 9. The electrode layers 51 and 53 are electrically connected to the outer electrodes 61 and 63 in the direction of the lower surface 11 of the semiconductor base 10. The electrode layers 52 and 54 are electrically connected to the outer electrodes 62 and 64 in the direction of the upper surface 12 of the semiconductor base 10.

According to the present modification, as illustrated in FIG. 13, the outer electrodes 61 and 62 that are electrically connected to the first capacitive portion 30A in the direction of the first base 10A are electrically isolated from the outer electrodes 63 and 64 that are electrically connected to the second capacitive portion 30B in the direction of the second base 10B. The through-electrode outer electrodes 65 and 66 are electrically isolated from the outer electrodes 61 to 64.

In an example illustrated in FIG. 11 and FIG. 12, the outer electrodes 61 and 63 are adjacent to both sides of the through-electrode outer electrode 65 in the X-direction so as to be spaced from the through-electrode outer electrode 65 on the lower surface of the semiconductor device 103. Similarly, the outer electrodes 62 and 64 are adjacent to both sides of the through-electrode outer electrode 66 in the X-direction so as to be spaced from the through-electrode outer electrode 66 on the upper surface of the semiconductor device 103. The through-electrode outer electrodes 65 and 66 and the outer electrodes 61 to 64 adjacent to both sides thereof are insulated from each other by the high-resistance portions 15 and 25 of the semiconductor base 10.

### Method of Forming Through Electrode

The semiconductor device 103 can be manufactured by using the same method as the semiconductor device 102 (FIG. 8 and FIG. 9) described above. For example, the through electrode 80 can be formed by using a method described below.

Portions in the direction of the back surfaces of the first base and the second base are ground as needed. Subsequently, conductive films such as Al films or Cu films are formed as the electrode portions on the back surfaces of the bases by using, for example, a sputtering method. Subsequently, surfaces of the electrode portions are polished or flattened as needed, and subsequently, the bases are bonded to each other. Consequently, the electrode portions that are formed on the back surfaces of the bases are bonded (for example, Cu—Cu bonding), and the through electrode is formed.

The electrode portions may be formed in a manner in which recessed portions are formed on the high-resistance portions on the back surfaces of the bases by, for example, etching, and the recessed portions are filled with a conductive material such as Cu instead of the method described above. Subsequently, the bases may be bonded to each other, and the electrode portions that are formed on the back surfaces of the bases may be bonded to each other (for example, Cu—Cu bonding) as in the above description.

According to the present modification, the through electrode 80 that is electrically connectable to, for example, an external wiring line is provided, and accordingly, the degree of freedom of design of the semiconductor device 103 can be increased.

As for the semiconductor device 103 according to the present modification, the through electrode 80 is disposed between at least a portion of the back surface (also referred to as a “first back surface”) 13a of the first base 10A and at least a portion of the back surface (also referred to as a “second back surface”) 13b of the second base 10B. With this structure, the through electrode 80 can be used as a bonding layer for the first base 10A and the second base 10B, and accordingly, the bonding strength between the bases 10A and 10B can be increased.

For example, the ratio of the area of the through electrode 80 that occupies the back surface 13 a or the back surface 13 b when viewed in the X-direction may be 50% or more (80% or more in an illustrated example). With this structure, the through electrode 80 that has decreased resistance can be formed. In the case where the electrode portions in the directions of the back surface 13a and the back surface 13b are bonded to each other, and the through electrode 80 is formed, the bonding strength between the bases 10A and 10B can be further increased by using bonding between the electrode portions.

As for the semiconductor device 103 according to the present modification, the first capacitive portion 30A and the second capacitive portion 30B have different electrostatic capacities. With this structure, the degree of freedom of design of the semiconductor device 103 can be increased.

The structure of the semiconductor device according to the present modification is not limited to the structure illustrated in FIG. 11 to FIG. 13. For example, the upper end portion or the lower end portion of the through electrode may function as an external terminal without providing the through-electrode outer electrodes. The circuit structure according to the present modification is not limited to an example illustrated in FIG. 13. The through electrode may be electrically connected to any one of the outer electrodes. The capacitances Ca1, Ca2, Cb1, and Cb2 may be connected to each other in parallel.

### Second Modification

A semiconductor device according to a second modification differs from the semiconductor device 103 according to the first modification in that a wiring layer that includes a through electrode is formed at a joint between the first base and the second base.

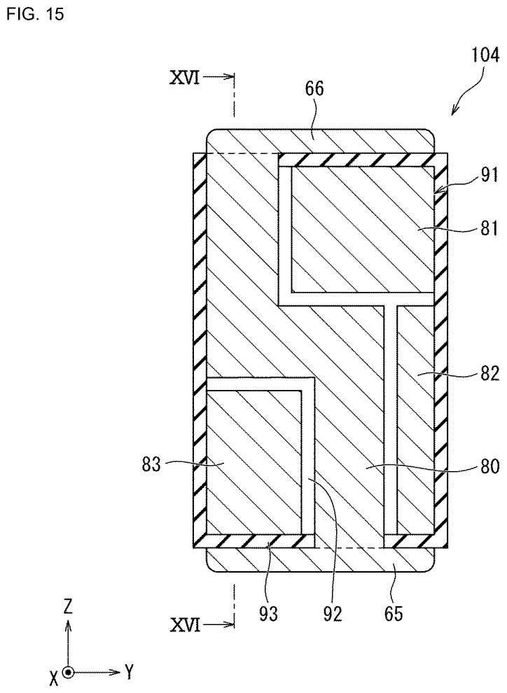

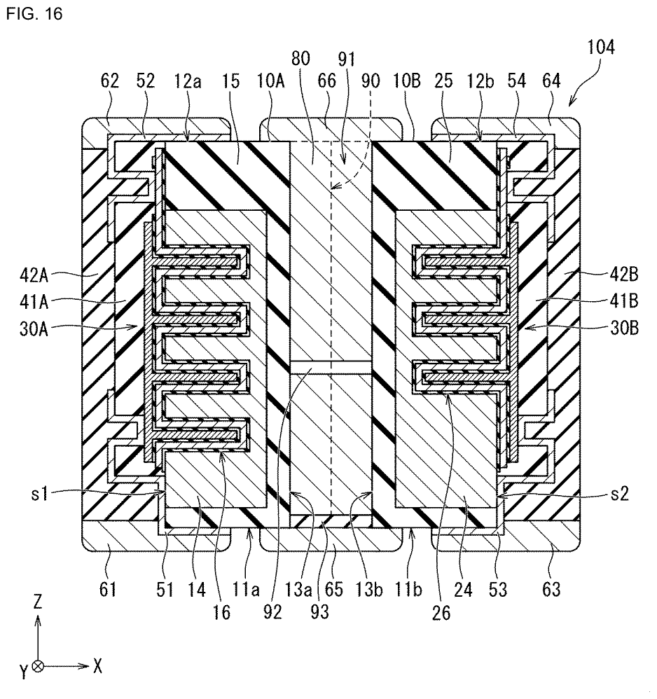

FIG. 14 is a schematic top view of the semiconductor device according to the second modification. FIG. 15 is a schematic sectional view of the semiconductor device taken along line XV-XV in FIG. 14. FIG. 16 is a schematic sectional view taken along line XVI-XVI illustrated in FIG. 14 and FIG. 15.

A semiconductor device 104 includes a wiring layer 91 between the back surface 13a of the first base 10A and the back surface 13b of the second base 10B.

The wiring layer 91 includes the through electrode 80 and at least one of (here, three) dummy electrodes 81 to 83. The through electrode 80 and the dummy electrodes 81 to 83 are spaced from each other when viewed in the X-direction. The through electrode 80 and the dummy electrodes 81 to 83 are formed as projecting portions relative to the back surfaces 13a and 13b of the bases 10A and 10B.

The through electrode 80 is patterned so as to extend from the lower surface 11 of the semiconductor base 10 to the upper surface 12. The through electrode 80 may include a bent portion when viewed in the X-direction. In an example illustrated in FIG. 15, the through electrode 80 includes two portions that extend in the Z-direction and a portion that is located between these portions and that extends in the Y-direction.

The dummy electrodes 81 to 83 are not drawn out from the semiconductor device 104 to the outside and are floating electrodes in this example. In the example illustrated in FIG. 15, as for the wiring layer 91, the dummy electrodes 81 to 83 have, for example, rectangular shapes and are disposed so as to fill regions of the back surfaces of the bases in which the through electrode 80 is not formed.

As illustrated in FIG. 15 and FIG. 16, the wiring layer 91 may further include void portions 92 between the dummy electrodes and/or between the dummy electrodes 81 to 83 and the through electrode 80.

Edge portions of the wiring layer 91 at which neither the through electrode nor the dummy electrodes are disposed may be filled with resin 93. The resin 93 that is filled makes it unlikely to dent an outer electrode that is formed after the bases are bonded due to a void in the wiring layer 91. In this example, the resin 93 is filled over all of the edge portions of the wiring layer 91, but the resin 93 may be filled in only a part of the edge portions (for example, only an underlying portion for the outer electrode).

### Method of Forming Wiring Layer

For example, the wiring layer 91 can be formed by using, for example, a subtractive method or a SAP (Semi Additive Process) method.

The thicknesses of the bases are adjusted, for example, by being ground as needed. Subsequently, electrode portions (such as Al films or Cu films) that serve as the through electrode and the dummy electrodes are formed on the back surfaces of the bases. For example, the electrode portions are formed by using electrolytic plating or a sputtering method. For example, the thicknesses of the electrode portions are 1 μm or less in the case where the sputtering method is used and are 20 μm or less in the case where the SAP (Semi Additive Process) method is used. The electrode portions on the back surfaces of the first base and the second base have patterns that match each other.

Subsequently, the surfaces of the electrode portions are flattened as needed, and the electrode portions of the bases are bonded to each other. Consequently, the electrode portions that are formed on the back surfaces of the bases are bonded (for example, Cu—Cu bonding), and the through electrode and the dummy electrodes are formed. The electrode portions are projecting portions relative to the back surfaces of the bases, and accordingly, a void portion is formed between the back surfaces of the bases with the electrode portions being bonded.

Subsequently, a portion that is exposed from a surface of the semiconductor base that is bonded among the void portions of the wiring layer is filled with resin. Subsequently, the surface of the wiring layer is flattened (for example, is flush with the upper surfaces or lower surfaces of the bases) as needed. This enables an outer electrode to be formed on a flat surface.

The through electrode or the dummy electrodes may be disposed up to edge portions of the back surfaces of the bases and may be exposed from the upper surface or lower surface of the semiconductor base. In this case, the exposed portions of the through electrode or the dummy electrodes may be flattened so as to be flush with the upper surfaces or lower surfaces of the bases.

The semiconductor device 104 according to the present modification includes the wiring layer 91 that includes the through electrode 80 between the first back surface 13a of the first base 10A and the second back surface 13b of the second base 10B. With this structure, the through electrode 80 can be formed with a desired pattern, and accordingly, the degree of freedom of design of the semiconductor device 104 can be increased. In addition, the bonding strength between the bases 10A and 10B can be increased in a manner in which the wiring layer 91 is formed such that the electrode portion that is disposed in the direction of the first base 10A and the electrode portion that is disposed in the direction of the second base 10B are bonded to each other.

As for the semiconductor device 104 according to the present modification, the wiring layer 91 includes the dummy electrodes 81 to 83 in addition to the through electrode 80. With this structure, a bonding area between the electrode portions can be increased, and accordingly, the bonding strength between the bases 10A and 10B can be further increased. For example, the total area of the through electrode 80 and the dummy electrodes 81 to 83 that occupy the area of the wiring layer 91 may be 60% or more (in the example illustrated in FIGS. 15, 80% or more).

According to the present modification, the wiring layer 91 includes the void portions 92. The void portions 92 can contribute to stress relief by serving as buffer portions for releasing stress. Accordingly, a failure due to stress can be reduced when the semiconductor device 104 is manufactured and when the semiconductor device 104 is used.

The layout of the wiring layer 91 is not limited to an illustrated example. A desired layout can be used for the wiring layer 91 depending on, for example, the use or size.

### Third Modification

A semiconductor device according to a third modification differs from the semiconductor device 104 illustrated in FIG. 15 and FIG. 16 in that an electrode portion of a wiring layer is disposed in a high-resistance portion of a base.

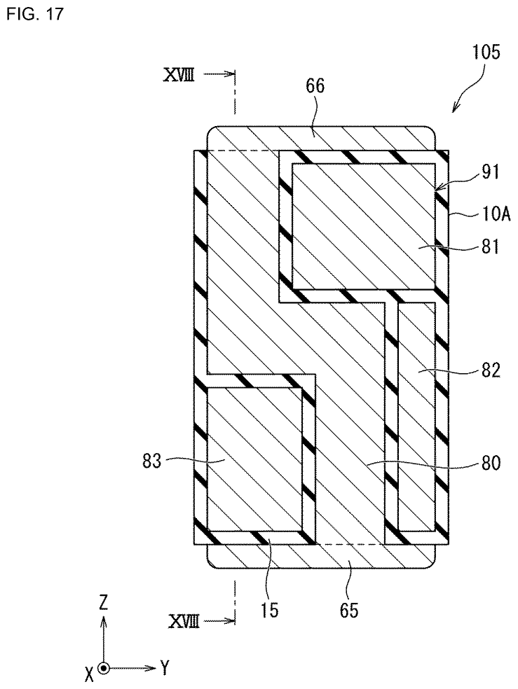

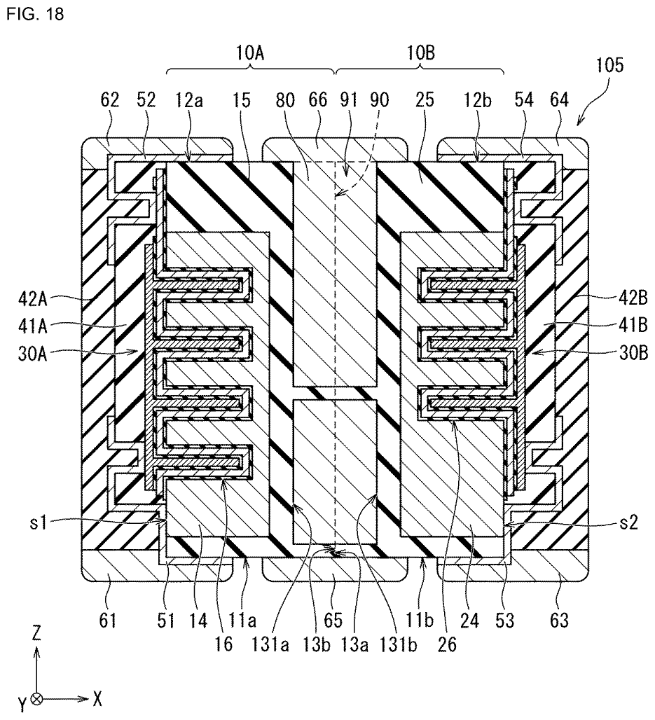

FIG. 17 is a schematic sectional view of the wiring layer of the semiconductor device according to the third modification. FIG. 18 is a schematic sectional view taken along line XVIII-XVIII in FIG. 17.

As for a semiconductor device 105, groove portions (recessed portions) 131a and 131b for forming electrode portions that serve as a through electrode or dummy electrodes are formed on the back surfaces 13a and 13b of the bases 10A and 10B. Portions of the back surfaces 13a and 13b of the bases 10A and 10B on which no grooves are formed are bonded to each other along the bonding surface 90. The through electrode 80 and the dummy electrodes 81 to 83 are disposed in a space that is formed with the groove portions 131a and 131b of the bases 10A and 10B facing each other. In other words, the high-resistance portions 15 and 25 are located between the electrodes in the wiring layer 91.

### Method of Forming Wiring Layer

The wiring layer 91 according to the present modification can be formed by using, for example, a damascene method.

Groove portions (recessed portions) are formed on the high-resistance portions on the back surfaces of the bases by, for example, etching. Subsequently, the groove portions are filled with a conductive material such as Cu by, for example, filled via plating. For example, after barrier layers and seed layers are formed in the groove portions by using, for example, a sputtering method, a conductive material such as Cu can be filled by, for example, electrolytic plating. In this way, the electrode portions can be formed in the groove portions of the back surfaces of the bases. Subsequently, parts of the electrode portions that project from the groove portions may be flattened by, for example, a CMP (chemical-mechanical polishing) method. This enables the surfaces of the electrode portions and the surfaces of the bases (here, the surfaces of the high-resistance portions) to be flush with each other regarding the back surfaces of the bases.

Subsequently, the bases that include the electrode portions in the grooves are bonded to each other. The electrode portions that are formed on the back surfaces of the bases are bonded to each other (for example, Cu—Cu bonding) and serve as the through electrode or the dummy electrodes. The high-resistance portions (regions in which no electrode portions are formed) of the bases are bonded to each other.

According to the present modification, the bonding surfaces (the high-resistance portions and the electrode portions) located in the direction of the back surfaces of the bases are flattened, and accordingly, not only the electrode portions but also the high-resistance portions are bonded to each other along the bonding surface 90. Accordingly, the contact area between the first base 10A and the second base 10B can be ensured, and the bonding strength can be further increased.

### Third Embodiment

FIG. 19 is a schematic perspective view of a semiconductor device according to a third embodiment. As illustrated in FIG. 19, capacitive portions in a semiconductor device 106 include multiple capacitor portions (simply referred to as “portions” in some cases) 30p that are spaced from each other in parallel. An example of the semiconductor device 106 is a capacitor array.

The capacitor portions 30p may have the same structure as the capacitive portions described above. According to the present embodiment, N (N is an integer of 2 or more, and in FIG. 19, N=3) capacitor portions 30p are spaced from each other in the Y-direction and in the direction of the first surface of the semiconductor base 10. For example, the capacitor portions 30p adjacent to each other may be insulated from each other by the high-resistance portions of the semiconductor base 10. Each capacitor portion 30p is electrically connected to a pair of the outer electrodes 61 and 62.

Similarly, as illustrated in FIG. 19, N capacitive portions and outer electrodes may be spaced from each other in the Y-direction and in the direction of the second surface of the semiconductor base 10. The number of the capacitive portions (the number of arrays) can be doubled (2×N) by disposing the capacitive portions also in the direction of the second surface.

According to the present embodiment, the multiple capacitor portions 30p can be formed on a side surface (such as the first surface) of the semiconductor base 10. Accordingly, the mounting area can be further decreased. Otherwise, the mounting area is inhibited from increasing, and the capacitance can be further increased.

In an example illustrated in FIG. 19, the three capacitor portions 30p are arranged in the Y-direction, but the number of the capacitive portions and an arrangement method, for example, are not limited to the illustrated example. In FIG. 19, the outer electrodes 61 and 62 are disposed for the respective capacitor portions 30p, but a common outer electrode may be disposed for the multiple capacitor portions 30p. The semiconductor base 10 is configured to include the two bases 10A and 10B that are bonded along the bonding surface 90, but a single base (such as a Si substrate) may be used as the semiconductor base 10.

### Fourth Embodiment

According to a fourth embodiment, a circuit substrate includes any one of the semiconductor devices described above. The circuit substrate according to the present embodiment includes the semiconductor device and a mounting substrate that has a mounting surface. The semiconductor device is mounted on the mounting surface such that a lower surface of a semiconductor base faces the mounting surface (see FIG. 4H).

FIG. 20 is a schematic sectional view of the circuit substrate according to the fourth embodiment.

A circuit substrate 201 includes the mounting substrate 110 and semiconductor devices 107 and 108. Also according to the present embodiment, the mounting surface 110s of the mounting substrate 110 faces lower surfaces of the semiconductor devices 107 and 108.

The mounting substrate 110 includes a core material 130, insulating members, and multiple wiring layers. In an example illustrated in FIG. 20, the insulating members include a lower insulating member 112L that is located below the core material 130 in the Z-direction and 112U that is located above the core material 130. The wiring layers include at least one wiring layer 120L that is located inside the lower insulating member 112L and at least one wiring layer 120U that is located inside the upper insulating member 112U. The core material 130 is an insulating layer. For example, the thickness of the core material 130 is about 500 μm to 1200 μm (for example, 1000 μm).

The semiconductor devices 107 and 108 are components that include trench portions and capacitive portions on side surfaces. The structure of each of the semiconductor devices 107 and 108 is not particularly limited to an illustrated example but may be that of the semiconductor device according to any one of the embodiments or the modifications described above. The heights of the semiconductor devices 107 and 108 in the Z-direction are slightly less than the thickness of the core material 130 in the Z-direction but are at substantially the same level. The semiconductor devices 107 and 108 are disposed between an upper end 130b and a lower end 130a of the core material 130 in the Z-direction. The lower surfaces of the semiconductor devices 107 and 108 are located near the lower end 130a of the core material 130 in the X-direction. The upper surfaces of the semiconductor devices 107 and 108 are located near the upper end 130b of the core material 130 in the X-direction. In an example illustrated in FIG. 20, the core material 130 has through-holes that extend from the lower end 130a to the upper end 130b, and the semiconductor devices 107 and 108 are disposed in the through-holes. Portions of the through-holes at which the semiconductor devices 107 and 108 are not disposed may be filled with resin.

External terminals located in the direction of the lower surfaces of the semiconductor devices 107 and 108 are electrically connected to a wiring line in the wiring layer 120L, and external terminals located in the direction of the upper surfaces are electrically connected to a wiring line in the wiring layer 120U. The external terminals of the semiconductor devices 107 and 108 may be outer electrodes that are disposed on a surface of the semiconductor base or may be parts of a low-resistance portion of the semiconductor base. For example, an outer electrode is provided as an external terminal in the direction of the upper surface of the semiconductor device 107. The outer electrode is electrically connected to the wiring line in the wiring layer 120U with a connection conductor 212 in the upper insulating member 112U interposed therebetween. The low-resistance portion of the semiconductor base is exposed from the lower surface of the semiconductor device 107. The exposed part of the low-resistance portion is connected to (for example, is in direct contact with) a connection conductor 211 in the lower insulating member 112L.

A through-electrode external terminal that is located in the direction of a lower end portion of the through electrode 80 of the semiconductor device 107 is electrically connected to the wiring line in the wiring layer 120L with a connection conductor 213 interposed therebetween. A through-electrode external terminal that is located in the direction of an upper end portion of the through electrode 80 is electrically connected to the wiring line in the wiring layer 120U with a connection conductor 214 interposed therebetween. In this way, the wiring lines in the wiring layers 120L and 120U can be electrically connected to each other with the through electrode 80 interposed therebetween.

Each through-electrode external terminal may be an outer electrode that is formed on a surface of the semiconductor base, and an end portion of the through electrode 80 may be used as the through-electrode external terminal. For example, a through-electrode outer electrode is disposed as a through-electrode external terminal in the direction of the upper surface of the semiconductor device 107. The lower end portion of the through electrode 80 is exposed from the lower surface of the semiconductor device 107. The exposed portion of the through electrode 80 is connected to the connection conductor 213 in the lower insulating member 112L.

According to the present embodiment, the height of the semiconductor device 100 can be set with a high degree of freedom depending on the height of the core material 130. Accordingly, the semiconductor device 100 is easily contained in, for example, a circuit substrate that includes the core material 130 that is relatively thick. In the case where the semiconductor device 100 includes the through electrode 80, a signal can flow in the thickness direction (the Z-direction) of the core material 130 via the through electrode 80. For this reason, for example, when a PMIC (Power Management IC) is provided below the core material 130, and a processor IC such as an XPU is provided above the core material 130, a low-loss signal path can be formed between these ICs via the through electrode 80.

### Modification

FIG. 21 is a schematic sectional view of a circuit substrate according to a modification.

A circuit substrate 202 includes a first mounting substrate (such as a motherboard) 110A, a second mounting substrate (such as a PKG substrate) 110B, semiconductor devices 109, and connection members 140. For example, an integrated circuit component (IC) 150 is disposed on an upper surface of the second mounting substrate 110B.

The first mounting substrate 110A and the second mounting substrate 110B face each other in the Z-direction with the semiconductor device 100 interposed therebetween. The semiconductor devices 109 are mounted on the mounting surface 110s of the first mounting substrate 110A in the direction of lower surfaces thereof. The semiconductor devices 109 are mounted on the mounting surface of the second mounting substrate 110B in the direction of upper surfaces thereof.

The semiconductor devices 109 are components that include trench portions and capacitive portions on side surfaces. Each semiconductor device 109 can be the semiconductor device according to any one of the embodiments or the modifications described above. For example, the semiconductor devices 109 function as bridges. Accordingly, a signal can flow between a wiring line in the first mounting substrate 110A and a wiring line in the second mounting substrate 110B via the semiconductor devices 109.

The connection members 140 are disposed between the mounting substrates 110A and 110B. Examples of the connection members 140 include solder bumps and copper pillars. In an example illustrated in FIG. 21, the multiple connection members 140 and the multiple semiconductor devices 109 are spaced from each other in a plan view when viewed in the Z-direction.

According to the present modification, the semiconductor devices 109 are included between the mounting substrates 110A and 110B, and accordingly, a signal and power can be transmitted between the mounting substrates 110A and 110B, and noise can be removed.

For example, the heights of the semiconductor devices 109 in the Z-direction can be designed in a manner in which semiconductor substrates are diced with a desired width. Accordingly, the connection members 140 and the semiconductor devices 109 can be easily mounted between the mounting substrates 110A and 110B, for example, in a manner in which the heights of the semiconductor devices 109 are set depending on the thicknesses (for example, about 400 μm) of the connection members 140.

In FIG. 21, the connection members 140 such as solder bumps are disposed in a space between the mounting substrates 110A and 110B, but only the semiconductor devices 109 may be disposed therein.

The above description can be also expressed as follows.

A semiconductor device provided according to a first aspect of the present disclosure includes a semiconductor base that has a lower surface, an upper surface spaced from the lower surface in a height direction, and a side surface connecting the upper surface and the lower surface; and a capacitive portion that is disposed in a direction of the side surface of the semiconductor base. The lower surface is to face a mounting surface on which the semiconductor device is to be mounted. The capacitive portion has a multilayer structure including at least a first dielectric layer that is disposed along the side surface and a first conductive layer and a second conductive layer that face each other with the first dielectric layer interposed therebetween. The semiconductor base includes at least one trench portion that has an opening in the side surface, and at least a part of the capacitive portion is located inside the at least one trench portion.

The semiconductor device described in the first aspect and provided according to a second aspect of the present disclosure further includes a pair of external terminals that are electrically connected to the capacitive portion. One of the pair of external terminals is located in a direction of the lower surface of the semiconductor base, and the other of the pair of external terminals is located in a direction of the upper surface of the semiconductor base.

As for the semiconductor device described in the first aspect or the second aspect and provided according to a third aspect of the present disclosure, a depth direction from the opening of the at least one trench portion is parallel with the mounting surface.

The semiconductor device described in any one of the first aspect to the third aspect and provided according to a fourth aspect of the present disclosure further includes an electrode layer that is electrically connected to the capacitive portion. The multilayer structure of the capacitive portion further includes a second dielectric layer that is located on an opposite side of the second conductive layer from the first dielectric layer and a third conductive layer that faces the second conductive layer with the second dielectric layer interposed therebetween, and the first conductive layer and the third conductive layer are electrically connected to the electrode layer.

The semiconductor device described in any one of the first aspect to the third aspect and provided according to a fifth aspect of the present disclosure further includes an electrode layer that is electrically connected to the capacitive portion, and the electrode layer extends in a direction from the side surface of the semiconductor base to the lower surface or the upper surface.

As for the semiconductor device described in any one of the first aspect to the fifth aspect and provided according to a sixth aspect of the present disclosure, the side surface of the semiconductor base includes a first surface and a second surface that is spaced from the first surface in a first direction intersecting with the first surface. The opening of the at least one trench portion is located in the first surface, and the semiconductor device further comprises a backside electrode layer that is disposed on the second surface of the semiconductor base.

As for the semiconductor device described in any one of the first aspect to the fifth aspect and provided according to a seventh aspect of the present disclosure, the side surface of the semiconductor base includes a first surface and a second surface that is spaced from the first surface in a first direction intersecting with the first surface, and the capacitive portion includes a first capacitive portion that is located in a direction of the first surface and a second capacitive portion that is located in a direction of the second surface. Also, the at least one trench portion includes at least one first trench portion that has an opening in the first surface and at least one second trench portion that has an opening in the second surface, at least a part of the first capacitive portion is located inside the at least one first trench portion, and at least a part of the second capacitive portion is located inside the at least one second trench portion.

As for the semiconductor device described in the seventh aspect and provided according to an eighth aspect of the present disclosure, the first capacitive portion and the second capacitive portion have different electrostatic capacities.

The semiconductor device described in the seventh aspect or the eighth aspect and provided according to a ninth aspect of the present disclosure further includes a through electrode that extends through the semiconductor base from the lower surface to the upper surface.

As for the semiconductor device described in the ninth aspect and provided according to a tenth aspect of the present disclosure, the semiconductor base includes a first base on which the at least one first trench portion is formed; and a second base on which the at least one second trench portion is formed. The first base has a first back surface that is spaced from the first surface in the first direction. The second base has a first back surface that is spaced from the first surface in the first direction, and the through electrode is disposed between at least a portion of the first back surface of the first base and at least a portion of a second back surface of the second base.

As for the semiconductor device described in the tenth aspect and provided according to an eleventh aspect of the present disclosure, a ratio of an area of the through electrode that occupies the first back surface or the second back surface when viewed in the first direction is 50% or more.

The semiconductor device described in the tenth aspect or the eleventh aspect and provided according to a twelfth aspect of the present disclosure further includes a wiring layer that is located between the first back surface of the first base and the second back surface of the second base, and the wiring layer includes the through electrode and a dummy electrode that is spaced from the through electrode when viewed in the first direction.

As for the semiconductor device described in the twelfth aspect and provided according to a thirteenth aspect of the present disclosure, the wiring layer further includes a void portion.

As for the semiconductor device described in any one of the first aspect to the thirteenth aspect and provided according to a fourteenth aspect of the present disclosure, the capacitive portion includes multiple portions that are spaced from each other in parallel on the side surface.

As for the semiconductor device described in any one of the first aspect to the fourteenth aspect and provided according to a fifteenth aspect of the present disclosure, the semiconductor base includes a low-resistance portion that is composed of a low-resistance semiconductor and that is conductive, and the first conductive layer or the second conductive layer of the capacitive portion includes the low-resistance portion.

As for the semiconductor device described in any one of the first aspect to the fifteenth aspect and provided according to a sixteenth aspect of the present disclosure, the semiconductor base includes a low-resistance portion that is composed of a low-resistance semiconductor and that is conductive, and a part of the low-resistance portion is exposed from a surface of the semiconductor device and functions as an external terminal.

A circuit substrate according to a seventeenth aspect of the present disclosure includes the semiconductor device described in any one of the first aspect to the sixteenth aspect; and a mounting substrate that has the mounting surface. The semiconductor device is mounted on the mounting surface such that the lower surface of the semiconductor base faces the mounting surface of the mounting substrate.

As for the circuit substrate described in the seventeenth aspect and provided according to an eighteenth aspect of the present disclosure, the mounting substrate includes a core material, and the semiconductor device is disposed between an upper end and a lower end of the core material in the height direction of the semiconductor device.

The circuit substrate described in the seventeenth aspect and provided according to a nineteenth aspect of the present disclosure further includes another mounting substrate that faces the mounting substrate with the semiconductor device interposed therebetween in the height direction of the semiconductor device, and the semiconductor device is mounted on a mounting surface of the other mounting substrate such that the upper surface of the semiconductor base faces the mounting surface of the other mounting substrate.

As for the semiconductor device described in any one of the tenth aspect to the twelfth aspect and provided according to another aspect of the present disclosure, at least a portion of the through electrode is located in a space that is formed with a groove that is formed on the first back surface of the first base facing a groove that is formed on the second back surface of the second base.

The semiconductor device described in the fourth aspect or the fifth aspect and provided according to another aspect of the present disclosure further includes an outer electrode that is located opposite the semiconductor base of the electrode layer in the direction of the lower surface or in the direction of the upper surface of the semiconductor base.

As for the semiconductor device described in any one of the first aspect to the sixteenth aspect and provided according to another aspect of the present disclosure, thicknesses of the first conductive layer and the second conductive layer are equal to or more than twice a thickness of the first dielectric layer.

As for the semiconductor device described in any one of the first aspect to the sixteenth aspect and provided according to another aspect of the present disclosure, a height of the semiconductor base from the lower surface to the upper surface is 0.725 μm or more.

As for the semiconductor device described in any one of the first aspect to the sixteenth aspect and provided according to another aspect of the present disclosure, a height of the semiconductor base from the lower surface to the upper surface is greater than the maximum width of the lower surface.

An appropriate combination of embodiments among the various embodiments described above enables the effects thereof to be exerted.

The present disclosure is sufficiently described appropriately with reference to the drawings regarding preferred embodiments, and various modifications and alterations are obvious to a person skilled in the art. It is to be understood that the modifications and the alterations are included therein, provided that the modifications and the alterations are not out of the scope of the present disclosure depending on the attached claims.

What is claimed is:

1. A semiconductor device comprising:
a semiconductor base that has a lower surface, an upper surface spaced from the lower surface in a height direction, and a side surface connecting the upper surface and the lower surface; and
a capacitive portion that is disposed in a direction of the side surface of the semiconductor base,
wherein
the lower surface is configured to face a mounting surface on which the semiconductor device is to be mounted,
the capacitive portion has a multilayer structure including at least a first dielectric layer that is along the side surface and a first conductive layer and a second conductive layer that face each other with the first dielectric layer interposed therebetween,
the semiconductor base includes at least one trench portion that has an opening in the side surface, and
at least a part of the capacitive portion is inside the at least one trench portion.

2. The semiconductor device according to claim 1, further comprising:
a pair of external terminals that are electrically connected to the capacitive portion,
wherein
one of the pair of external terminals is located in a direction of the lower surface of the semiconductor base, and
an other of the pair of external terminals is located in a direction of the upper surface of the semiconductor base.

3. The semiconductor device according to claim 1, wherein
a depth direction from the opening of the at least one trench portion is parallel with the mounting surface.

4. The semiconductor device according to claim 1, further comprising:
an electrode layer that is electrically connected to the capacitive portion,
wherein
the multilayer structure of the capacitive portion further includes a second dielectric layer that is on an opposite side of the second conductive layer from the first dielectric layer and a third conductive layer that faces the second conductive layer with the second dielectric layer interposed therebetween, and
the first conductive layer and the third conductive layer are electrically connected to the electrode layer.

5. The semiconductor device according to claim 1, further comprising:
an electrode layer that is electrically connected to the capacitive portion,
wherein the electrode layer extends in a direction from the side surface of the semiconductor base to the lower surface or the upper surface.

6. The semiconductor device according to claim 1, wherein
the side surface of the semiconductor base includes a first surface and a second surface that is spaced from the first surface in a first direction intersecting with the first surface,
the opening of the at least one trench portion is in the first surface, and
wherein the semiconductor device further comprises a backside electrode layer that is on the second surface of the semiconductor base.

7. The semiconductor device according to claim 1, wherein
the side surface of the semiconductor base includes a first surface and a second surface that is spaced from the first surface in a first direction intersecting with the first surface,
the capacitive portion includes a first capacitive portion that is located in a direction of the first surface and a second capacitive portion that is located in a direction of the second surface,
the at least one trench portion includes at least one first trench portion that has an opening in the first surface and at least one second trench portion that has an opening in the second surface,
at least a part of the first capacitive portion is inside the at least one first trench portion, and
wherein at least a part of the second capacitive portion is inside the at least one second trench portion.

8. The semiconductor device according to claim 7, wherein
the first capacitive portion and the second capacitive portion have different electrostatic capacities.

9. The semiconductor device according to claim 7, further comprising:
a through electrode that extends through the semiconductor base from the lower surface to the upper surface.

10. The semiconductor device according to claim 9, wherein
the semiconductor base includes:
a first base on which the at least one first trench portion is present; and
a second base on which the at least one second trench portion is present,
the first base has a first back surface that is spaced from the first surface in the first direction,
the second base has a first back surface that is spaced from the first surface in the first direction, and
the through electrode is between at least a portion of the first back surface of the first base and at least a portion of a second back surface of the second base.

11. The semiconductor device according to claim 10, wherein
a ratio of an area of the through electrode that occupies the first back surface or the second back surface when viewed in the first direction is 50% or more.

12. The semiconductor device according to claim 10, further comprising:
a wiring layer that is between the first back surface of the first base and the second back surface of the second base,
the wiring layer includes the through electrode and a dummy electrode that is spaced from the through electrode when viewed in the first direction.

13. The semiconductor device according to claim 12, wherein
the wiring layer further includes a void portion.

14. The semiconductor device according to claim 1, wherein
the capacitive portion includes multiple portions that are spaced from each other in parallel on the side surface.

15. The semiconductor device according to claim 1, wherein
the semiconductor base includes a low-resistance portion that includes a low-resistance semiconductor and that is conductive, and
the first conductive layer or the second conductive layer of the capacitive portion includes the low-resistance portion.

16. The semiconductor device according to claim 1, wherein
the semiconductor base includes a low-resistance portion that includes a low-resistance semiconductor and that is conductive, and
a part of the low-resistance portion is exposed from a surface of the semiconductor device and functions as an external terminal.

17. A circuit substrate comprising:
the semiconductor device according to claim 1; and
a mounting substrate that has the mounting surface,
wherein the semiconductor device is mounted on the mounting surface such that the lower surface of the semiconductor base faces the mounting surface of the mounting substrate.

18. The circuit substrate according to claim 17, wherein
the mounting substrate includes a core material, and
the semiconductor device is between an upper end and a lower end of the core material in the height direction of the semiconductor device.

19. The circuit substrate according to claim 17, further comprising:
another mounting substrate that faces the mounting substrate with the semiconductor device interposed therebetween in the height direction of the semiconductor device, and
wherein the semiconductor device is mounted on a mounting surface of the another mounting substrate such that the upper surface of the semiconductor base faces the mounting surface of the another mounting substrate.

20. The semiconductor device according to claim 2, wherein
a depth direction from the opening of the at least one trench portion is parallel with the mounting surface.
